(19) United States
(12) Patent Application Publication
(10) Pub. No.: US 2025/0344903 A1
(43) Pub. Date: Nov. 13, 2025

(54) FEED SYSTEM FOR APPARATUS FOR MAKING COMPRESSED FOOD

(71) Applicant: Frito-Lay North America, Inc., Plano, TX (US)

(72) Inventors: Bradley Scott Shepard, Wylie, TX (US); Baqar Abbas, Rugby (GB); Scott James Fagan, Dallas, TX (US); Steven Jonathan Clarke, Marlow (GB); Thomas Gary Sutherland Miles, Wheathampstead (GB); Xavier Jean Rene Herpe, Cambridge (GB); Joshua Andrew Burton-Brown, Hertford (GB); Anna Elinor Parker, Cambridge (GB)

(21) Appl. No.: 19/201,829

(22) Filed: May 7, 2025

Related U.S. Application Data
(60) Provisional application No. 63/646,240, filed on May 13, 2024.
(60) Provisional application No. 63/704,280, filed on Oct. 7, 2024.
(60) Provisional application No. 63/771,145, filed on Mar. 13, 2025.

(51) Int. Cl. A47J 43/00; A23P 30/32

(52) U.S. Cl. CPC A47J 43/00; A23P 30/32

(57) ABSTRACT

A feed system for delivering raw ingredients to an apparatus for making food product comprises a first feed assembly and a first hopper. The first feed assembly is configured to dose and deliver the raw ingredients to the apparatus. The first feed assembly includes a first hopper that stores a first amount of the raw ingredients therein, a first metering unit that apportions a dose of the raw ingredients having a predetermined volume from the first amount of the raw ingredients in the first hopper, and a first dosing unit that receives and delivers the dose of the raw ingredients to the apparatus. The first hopper includes a hopper housing that stores the first amount of raw ingredients and a distribution unit configured to move the first amount of raw ingredients in the hopper housing to urge the raw ingredients into the metering unit.

### CROSS REFERENCE TO RELATED APPLICATIONS

This application claims priority to and the benefit of U.S. Provisional Patent Application No. 63/646,240, filed 13 May 2024, U.S. Provisional Patent Application No. 63/704,280, filed 7 Oct. 2024, and U.S. Provisional Patent Application No. 63/771,145, filed 13 Mar. 2025, the disclosures of which are now expressly incorporated herein by reference.

### BACKGROUND

The present invention generally relates to an apparatus for compressing, cooking, and expanding food product and a method of performing the same.

In the past few decades, a strong trend emerged in the food industry to develop more nutritious and more healthy snacks. Health-conscious consumers increasingly demand food products that include lower fat content, offer more balanced amounts of protein and carbohydrates, or are generally more health-promoting than traditional snacks such as candies, chips, crackers, and the like. As a result, the food industry has attempted to tackle the challenges of making wholesome snack food products out of conventional or alternative ingredients and with less fat or sugar while maintaining or improving the taste and texture of such food products.

In the trend of healthy snacking, puffed snacks have become more and more popular due to their inherent lightness, crispy texture, and ability to accommodate flavoring. As one example, automatic machines for the making of rice crackers and similar puffed or popped granular cakes by pressure-baking and expanding a food-starch containing material in a heated mold are known from the prior art to exist in a number of distinct machine variants. It remains a desire to produce such puffed snacks economically while providing batch uniformity and consistency.

### SUMMARY

Aspects and embodiments of the described apparatus for making expanded food product and methods of making product using the described apparatus are set out in the appended claims. These and other aspects and embodiments of the described apparatus for making expanded food product and methods of making such product are also described below.

According to one aspect of the disclosure, an apparatus for making expanded food product includes a first compression head assembly and a feed system. The first compression head assembly is adapted to compress and heat raw ingredients to provide the food product. The feed system meters and delivers the raw ingredients to the first compression head assembly.

In some embodiments, the first compression head assembly is included in a carriage system of the apparatus. The carriage system further includes a moving base coupled with the first compression head assembly to move the first compression head assembly along a carriage path relative to ground. The feed system meters and delivers the raw ingredients to the first compression head assembly as the first compression head assembly moves along the carriage path. In some embodiments, the carriage system includes a plurality of compression head assemblies, including the first compression head assembly.

In some embodiments, the feed system includes a feed assembly configured to dose and deliver the raw ingredients to the apparatus. The feed assembly may include a hopper that stores an amount of the raw ingredients therein, a metering unit that apportions a plurality of doses of the raw ingredients having predetermined volume from the amount of the raw ingredients in the hopper, and a dosing unit that receives the plurality of doses of the raw ingredients from the metering unit and delivers the plurality of doses of the raw ingredients to the compression head assembly.

In some embodiments, the compression head assembly includes a bottom platen assembly and a top platen assembly. The bottom platen assembly includes a compression head frame, a bottom punch assembly, and a bottom actuator coupled with the bottom platen frame and the bottom punch assembly to move selectively, the bottom punch assembly relative to the bottom platen frame. The top platen assembly includes a frame coupled with the compression head frame, a top punch assembly, and a top actuator coupled with the frame and the top punch assembly to move selectively the top punch assembly relative to the frame. The top punch assembly and the bottom punch assembly are configured to compress and heat the raw ingredients to provide the food product.

In some embodiments, one or both of the bottom platen assembly and the top platen assembly include a connection manifold and a punch. The connection manifold is formed to include a slot having a first negative contour that extends axially through the connection manifold. The punch is configured to be received in the slot and is couple with the connection manifold to compress and heat the raw ingredients to make the food product. The punch may include a cook block for contacting the raw ingredients and a connection block that extends into the slot and couples the punch with the connection manifold. In some embodiments, a heater is coupled with the cook block and configured to heat the cook block. A ring plate is spaced apart from the connection manifold and formed to include an opening that receives the cook block of the punch during operation of the platen assembly to limit non-axial movement of the punch as the connection manifold moves the punch axially to compress and heat the raw ingredients.

In some embodiments, the connection block of the punch includes a connection block base, a connection post, and a slider plate. The connection block base is coupled with the cook block of the punch. The connection post has a first positive contour that mates with the first negative contour of the slot and extends away from the connection block base through the slot so that a gap is formed between the connection post and the connection manifold to allow alignment of the cook block with the hole in the ring plate. The slider plate may be removably coupled with the connection post and engaged with the connection manifold to block movement of the punch relative to the connection manifold.

The described apparatus for making expanded food product and methods of making product using the described apparatus for making expanded food product extends to methods, systems, kits of parts and apparatus substantially as described and/or as illustrated with reference to the accompanying figures.

The described apparatus for making expanded food product and methods of making product using the described apparatus for making expanded food product extends to any novel aspects or features described and/or illustrated. In addition, apparatus aspects may be applied to method aspects, and vice versa. Furthermore, any, some and/or all features in one aspect can be applied to any, some and/or all features in any other aspect, in any appropriate combination.

It should also be appreciated that particular combinations of the various features described and defined in any aspects of the described apparatus for making expanded food product and methods of making product using the described apparatus for making expanded food product can be implemented and/or supplied and/or used independently.

According to another aspect, a feed system for delivering raw ingredients to an apparatus for making food product comprises a first feed assembly configured to dose and deliver the raw ingredients to the apparatus. The first feed assembly may include a first hopper that stores a first amount of the raw ingredients therein. The first feed assembly may include a first metering unit that apportions a dose of the raw ingredients having a predetermined volume from the first amount of the raw ingredients in the first hopper. The first feed assembly may include a first dosing unit that receives the dose of the raw ingredients from the first metering unit and delivers the dose of the raw ingredients to the apparatus.

In some embodiments, the first hopper may include a hopper housing that stores the first amount of raw ingredients therein in a shallow bed. The first hopper may include a distribution unit configured to move the first amount of raw ingredients in the hopper housing to urge a portion of the first amount of the raw ingredients into the metering unit while preventing bridging of the raw material.

In some embodiments, the distribution unit moves the first amount of raw ingredients in a wave such that a first area of the hopper housing holds a first height of the raw ingredients and a second area of the hopper housing holds a second height of the raw ingredients that is less than the first height. The distribution unit may include a mixing blade that moves relative to the hopper housing to move the first amount of raw ingredients in the hopper housing. The mixing blade may include a first end that confronts a sidewall of the hopper housing and a second end that confronts the sidewall of the hopper housing to prevent the raw ingredients from passing between the mixing blade and the sidewall.

In some embodiments, the hopper housing is circular when viewed downwardly from above. The mixing blade may rotate about a rotation axis to uniformly urge the portion of the first amount of the raw ingredients into the metering unit.

In some embodiments, the feed system comprises a storage container assembly including a storage container that stores the raw ingredients therein and configured to distribute the raw ingredients to the first hopper. One of the storage container and the first hopper may include a filling duct having an outlet configured to direct the raw ingredients into the hopper housing. The outlet may be offset from a central axis of the hopper housing.

In some embodiments, the feed system comprises a storage container assembly including a storage container that stores the raw ingredients therein and configured to distribute the raw ingredients to the first hopper. The storage container assembly may include a valve configured to selectively open and close to control a volume of the first amount of the raw ingredients delivered to the hopper housing of the first hopper. The storage container assembly may include a controller programmed to open and close the valve such that the second height of the raw ingredients has a height in the hopper housing which exposes a bottom of the hopper housing in the second area of the hopper housing when viewed from above.

In some embodiments, the metering unit includes a first gate formed to include a first gate hole. The metering unit may include a second gate spaced apart from the first gate and may be formed to include a second gate hole. The metering unit may include a metering plate located between the first gate and the second gate and may be formed to include a metering hole. The metering hole may cooperate with the first gate and the second gate to cause the dose to have the predetermined volume.

In some embodiments, the metering plate is configured to move between a first position and a second position. In the first position, the metering hole may be aligned with a first gate hole to allow the raw ingredients in the first hopper to pass through the first gate hole and into the metering hole. In the first position, the metering hole may be misaligned with the second gate hole so that the raw ingredients in the metering hole are blocked from escaping the metering hole by the second gate.

In some embodiments, in the second position, the metering hole is misaligned with the first gate hole to block additional raw ingredients from the first hopper from passing into the metering hole. In the second position, the metering hole may be aligned with the second gate hole to allow the dose of the raw ingredients to move out of the metering hole and the second gate hole and into the first dosing unit so that the dosing unit stores the dose of the raw ingredients having the predetermined volume.

In some embodiments, the metering plate includes a metering wall formed to define the metering hole. The metering plate may include a side wall that extends from the metering wall to form a cavity in the metering plate that opens toward the second gate to allow inadvertent egress of the raw ingredients into the cavity. The metering plate may include a hole wall that extends from the metering wall around the metering hole.

In some embodiments, all holes formed in the metering plate are misaligned with the outlet of the filling duct.

In some embodiments, the metering plate is formed to include a relief hole that is spaced apart from the metering hole to allow inadvertent ingress of the raw ingredients to pass between the first gate and the metering plate. The relief hole may be misaligned with the first gate hole and any other holes in the first gate in response to the metering plate being in the first position and the second position. The relief hole may at least partially extend around the metering hole.

In some embodiments, the feed system comprises a base and a moving frame. The base may have a base frame and guide rail coupled with the base frame. The moving frame may be coupled with the guide rail and with the first feed assembly and may be configured to move the first feed assembly along a feed path relative to the base frame.

In some embodiments, the storage container assembly remains fixed with respect to the first feed assembly. In some embodiments, the base further includes a drive belt coupled with the base frame and the moving frame includes a frame body coupled with the first feed assembly.

In some embodiments, the base includes a guide coupled with the frame body and with the guide rail of the base. The base may include a drive unit coupled with the frame body. The drive unit may be engaged with the drive belt to selectively move the frame body along the feed path in a first direction and a second direction. The drive unit may include a motor and a spindle engaged with the drive belt and may be driven by the motor selectively to cause the spindle to rotate along the drive belt to move the moving frame along the feed path. In some embodiments, the feed path is arcuate.

In some embodiments, the feed system comprises a second feed assembly. The second feed assembly may include a second hopper that includes a second storage container. The second feed assembly may include a second hopper housing. The second feed assembly may include a second metering unit. The second feed assembly may include a second dosing unit.

In some embodiments, the hopper housing and the second hopper housing are coupled for movement together relative to the first storage container and the second storage container. The first feed assembly and the second feed assembly may be independently controlled. The first storage container may store a first raw ingredient and the second storage container may store a second raw ingredient different than the first raw ingredient. The first storage container and the second storage container may both be configured to selectively deliver their respective raw ingredient to the first feed assembly and the second feed assembly.

In some embodiments, the dosing unit includes a dosing plate formed to include a dosing hole. The dosing unit may include a dosing plate actuator configured to move the dosing plate. The dosing unit may include a dosing gate formed to include a dose gate hole. The dosing unit may include a dosing gate actuator configured to move the dosing gate independent of the dosing plate actuator.

In some embodiments, optionally, the dosing plate is located between the second gate and the dosing gate. Optionally, the dosing plate may be movable between a first position in which the dosing hole is aligned with the second gate hole and a second position in which the dosing hole is aligned with a hole formed in the apparatus.

In some embodiments, optionally, the dosing gate may be movable between a first position, a second position, and a third position. In the first position, the dosing gate hole may be misaligned with the dosing hole, the second gate hole, and the hole formed in the apparatus while the dosing plate is in the first position. In the second position, the dosing gate hole may be misaligned with the dosing hole while the dosing plate is in the second position. In the third position, the dosing gate hole may be aligned with the dosing hole and the hole formed in the apparatus while the dosing plate is in the second position to allow the raw ingredients to move from the dosing hole to the hole formed in the apparatus.

According to another aspect, a method for delivering raw ingredients to an apparatus for making food comprises moving a first amount of a raw material in a hopper housing. The method may comprise directing the raw material from the hopper housing into a metering unit to provide a dose of the raw ingredients having a predetermined volume. The method may comprise moving the dose of the raw ingredients to a dosing unit. The method may comprise delivering the dose of the raw ingredients from the dosing unit to the apparatus for making food product.

In some embodiments, the moving step is performed by a vibrator, impeller, sling, or blade. Moving the first amount of a raw material in the hopper housing may include forming a wave of the raw material such that a first portion of the raw material in the hopper housing has a first height and a second portion of the raw material in the hopper housing has a second height. Moving the first amount of a raw material in the hopper housing may be performed with a blade.

In some embodiments, the method comprises selectively conducting a volume of the raw ingredients from a first storage container to the hopper housing so that at least a portion of the bottom of the hopper housing is visible when viewed from above during the step of moving a first amount of a raw material in a hopper housing. The hopper housing may extend around an axis. Conducting the volume of the raw ingredients from the first storage container to the hopper housing may include directing the raw ingredients toward a location offset from the axis of the hopper housing.

In some embodiments, the method comprises moving the hopper housing, metering unit, and dosing unit about feed path relative to the apparatus. In some embodiments, the method comprises moving the apparatus about a carriage path relative to ground. In some embodiments, the method comprises aligning the dosing unit with the apparatus before delivering the dose of the raw ingredients from the dosing unit to the apparatus for making the food product.

### BRIEF DESCRIPTION OF THE DRAWINGS

The foregoing aspects and many of the attendant advantages of the present technology will become more readily appreciated by reference to the following Description, when taken in conjunction with the accompanying simplified drawings of exemplary embodiments. The illustrative, schematic drawings, briefly described below, are not to scale, are presented for ease of explanation and do not limit the scope of the inventions recited in the accompanying claims.

FIG. 1A is a perspective view of an apparatus for making expanded food product in accordance with the present disclosure.

FIG. 1B is a diagrammatic view of a method for making the expanded food product in accordance with the present disclosure.

FIG. 2 is a top view of the apparatus of FIG. 1.

FIG. 3 is a top diagrammatic view of the apparatus of FIG. 1 similar to FIG. 2 and depicting the operational process steps performed by the apparatus.

FIG. 4 is a diagrammatic view of the apparatus of FIG. 1 showing the apparatus includes a feed system, a carriage system, and an ejection and cleaning system.

FIG. 5 is a perspective view of the carriage system included in the apparatus showing the carriage system includes a plurality of compression head assemblies.

FIG. 6A is a diagrammatic view of one of the compression head assemblies included in the carriage system of FIG. 5.

6B is a diagrammatic view of another embodiment of a compression head assembly for use in the carriage system of FIG. 5.

FIG. 7 is a perspective view of one of the compression head assemblies included in the carriage system of FIG. 5.

FIG. 8 is a perspective view of the bottom platen assembly included in the compression head assembly of FIG. 7 with the top platen assembly removed to show features of the bottom platen assembly.

FIG. 9 is a perspective view of a bottom punch assembly included in the bottom platen assembly of FIG. 8.

FIG. 10 is a perspective view of a top platen assembly included in the compression head assembly of FIG. 7.

FIG. 11 is a perspective view of the top platen assembly of FIG. 10 with the top punch assembly removed to show features of the top platen assembly.

FIG. 12 is a perspective view of the top punch assembly included in the top platen assembly of FIG. 10.

FIG. 13 is an elevation view of the compression head assembly of FIG. 7 showing the bottom punch assembly in a lowered position to receive raw ingredients from the feed system.

FIG. 14 is an elevation view of the compression head assembly similar to FIG. 13 showing the top and bottom punch assemblies compressing and heating the raw ingredients to produce the food product.

FIG. 15 is an elevation view of the compression head assembly similar to FIG. 14 after the food product is produced showing the bottom punch assembly raised to position the food products for ejection.

FIG. 16 is a perspective view of the back side of the compression head assembly of FIG. 7.

FIG. 17 is a sectional view of the compression head assembly of FIG. 16 showing a guide of the top platen assembly coupled with a rail of the bottom platen assembly.

FIG. 18 is an elevation view of the compression head assembly of FIG. 7 showing a locking assembly in the locked position.

FIG. 19 is an elevation view of the compression head assembly of FIG. 18 showing the locking assembly in the unlocked position.

FIG. 20 is an elevation view of the compression head assembly similar to FIG. 19 showing the locking assembly in the unlocked position and the top platen assembly raised away from the bottom platen assembly to provide greater access for cleaning the apparatus.

FIG. 21 is an exploded view of components of the top punch assembly.

FIG. 22 is a top view of one of the punches located in a connection manifold of the top punch assembly of FIG. 12.

FIG. 23 is a sectional view through one of the punches and connection manifold of the top punch assembly of FIG. 12.

FIG. 24 is a perspective view of one of the top punches of the top punch assembly of FIG. 12.

FIG. 25 is a sectional view of the top punch of FIG. 24.

FIG. 26 is a perspective view of one of the bottom punches of the bottom punch assembly of FIG. 9.

FIG. 27 is a sectional view of the bottom punch of FIG. 26.

FIG. 28 is a perspective view of another embodiment of top punch adapted for use with a top punch assembly of the compression head assembly.

FIG. 29 is a sectional view of the top punch of FIG. 28.

FIG. 30 is a perspective view of another embodiment of bottom punch adapted for use with a bottom punch assembly of the compression head assembly.

FIG. 31 is a sectional view of the bottom punch of FIG. 30.

FIG. 32 is a perspective view of the feed system adapted for use in the apparatus of FIG. 1.

FIG. 33 is a sectional view through the feed system of FIG. 32.

FIG. 34 is a perspective view of a moving frame included in the feed system of FIG. 32.

FIG. 35 is a perspective view of a base included in the feed system of FIG. 32.

FIG. 36 is a perspective view of a first gate included in a metering unit of a feeding assembly that is coupled with the moving frame of FIG. 34 and included in the feed system of FIG. 32.

FIG. 37 is a perspective view of a metering plate included in the metering unit of the feeding assembly included in the feed system of FIG. 32.

FIG. 38 is a perspective view of a second gate included in the metering unit of the feeding assembly included in the feed system of FIG. 32.

FIG. 39 is a perspective view of a dosing plate included in a dosing unit of the feeding assembly included in the feed system of FIG. 32.

FIG. 40 is a perspective view of a dosing gate included in the dosing unit of the feeding assembly included in the feed system of FIG. 32.

FIG. 41 is a section and perspective view of the feeding assembly included in the feed system of FIG. 32.

FIG. 42 is another section and perspective view of the feeding assembly included in the feed system of FIG. 32.

FIG. 43 is a section view of another embodiment of a metering plate for use in the feeding assembly of the feed system of FIG. 32.

FIG. 44A is a top view of the embodiment of the metering plate of FIG. 43.

FIG. 44B is a perspective view of a metering plate included in a metering unit of a feeding assembly included a feed system of the apparatus of FIG. 32.

FIG. 44C is a top view of an embodiment of the metering plate of FIG. 32.

FIG. 45 is a diagrammatic sectional view of the dosing unit extending into a gap formed between the top platen assembly and the bottom platen assembly of the compression head assembly of FIG. 7.

FIG. 46 is a diagrammatic sectional view of the dosing unit, the top platen assembly, and the bottom platen assembly similar to FIG. 45 showing the dosing gate moved to allow raw ingredients to fall into the bottom platen assembly.

FIG. 47 is a top view of the apparatus of FIG. 1A showing the feed system in a first position.

FIG. 48A is a top view of the apparatus of FIG. 47 showing the feed system in a second position and suggesting that the feed system is configured to move temporarily with the rotation of the carriage system to deliver the raw ingredients to the compression head assemblies.

FIG. 48B is a top view of the apparatus of FIG. 47 showing the feed system returned to the first position while the compression head assemblies have continued to rotate about an axis of the apparatus.

FIG. 49 is a top view of the apparatus of FIG. 1A showing the feed system delivering raw ingredients to a first feed assembly.

FIG. 50 is a top view of the apparatus of FIG. 49 showing the feed system delivering a second blend of raw ingredients to the first feed assembly.

FIG. 51 is a perspective view of the ejection and cleaning system.

FIG. 52 is an elevation view of one of the compression head assemblies being cleaned by first and second wipers included in a cleaning assembly of the ejection and cleaning system shown in FIG. 51.

FIG. 53 is an elevation view of one of the compression head assemblies being cleaned by a laser head unit included in the cleaning assembly.

### DETAILED DESCRIPTION OF THE DRAWINGS

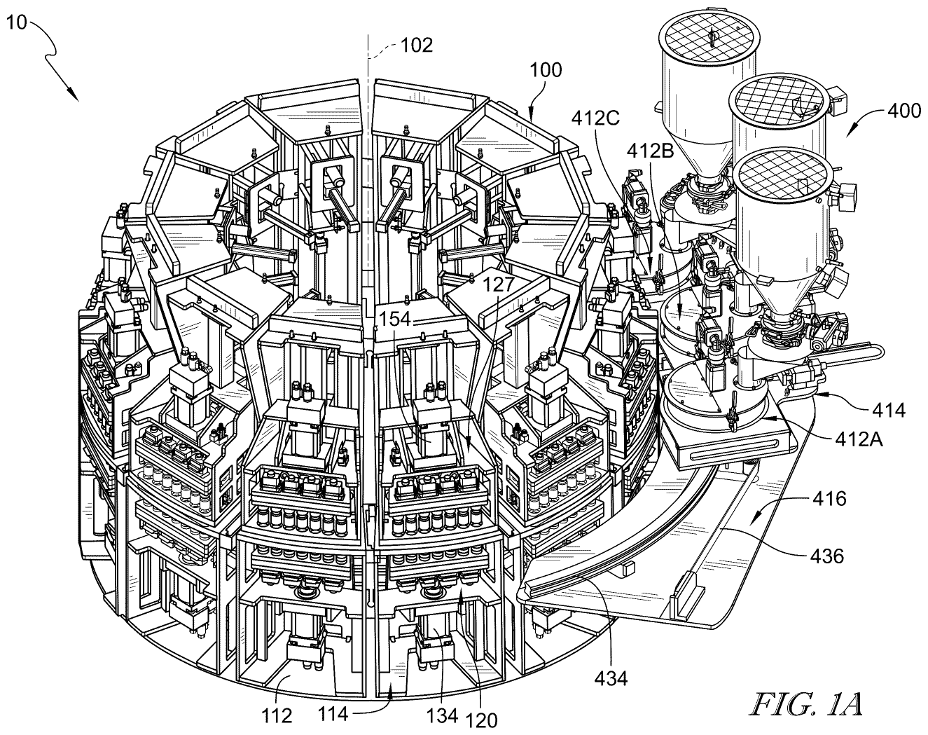

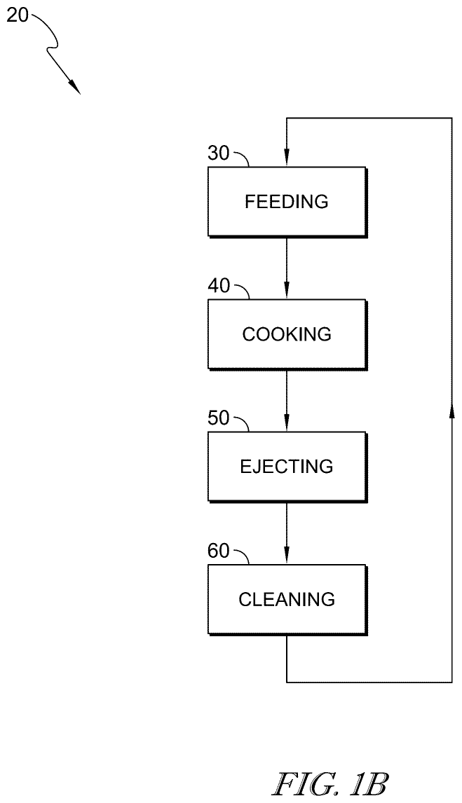

FIG. 1A depicts a perspective view of an apparatus 10 for making food product 14 that is expanded or popped (chips, puffs, etc.) as part of the cooking process in accordance with the present disclosure and FIG. 1B depicts a method of a process 20 for making the food product 14. In other embodiments, the apparatus 10 may be used to make products, for example, non-food products, with materials such as metal, plastic, or other similar materials. In other embodiments, the apparatus 10 may be used for different types of forming methods for products that are, for example, extruded, pressure formed, or other similar forming or manufacturing methods.

The process 20 is described in the present disclosure with the apparatus 10; though it will be appreciated that variations of the apparatus 10 as well as other equipment may be used in the process 20. The process 20 comprises a feeding step 30, a cooking step 40, a food removal or ejection step 50, and a cleaning step 60 as suggested in FIGS. 1B and 3. The apparatus 10 allows the process 20 to operate continuously, without interruption, which may allow for more food product 14 to be produced in a given amount of time and reduce or eliminate downtime for maintenance and cleaning. The cleaning step 60 and/or components may be optionally omitted in some embodiments.

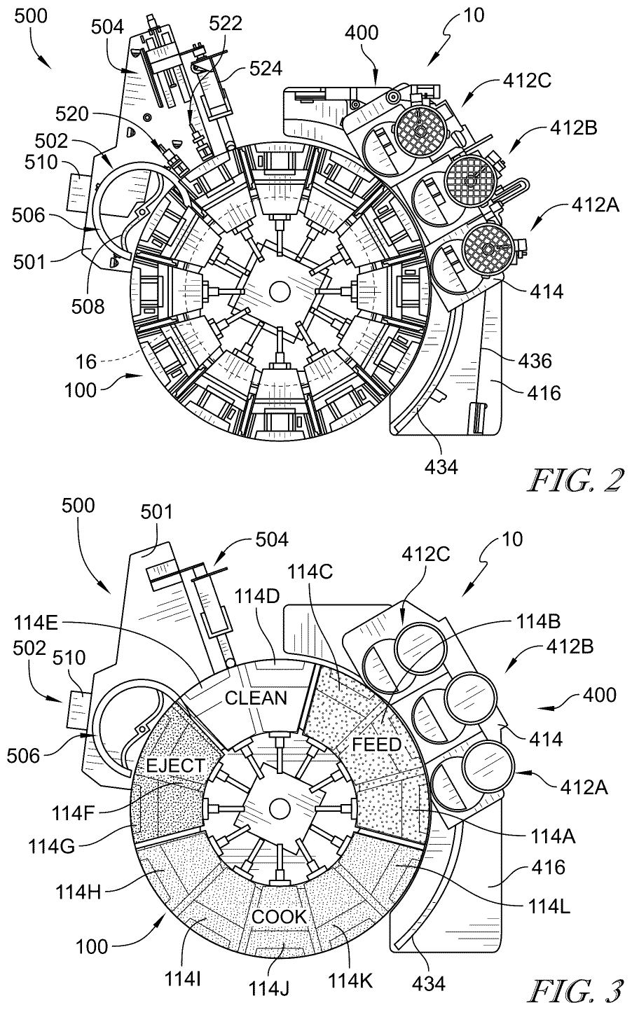

As depicted in FIGS. 2 and 3, the apparatus 10 comprises a carriage system 100, a feed system 400, and an ejection and cleaning system 500 in the illustrative embodiment. The carriage system 100 compresses, cooks, and expands raw ingredients 12 to provide expanded food product 14 in the cooking step 40. The feed system 400 delivers the raw ingredients 12 to the carriage system 100 during the feeding step 30 of the process 20. The ejection and cleaning system 500 move the expanded food product 14 away from the carriage system 100 in the ejection step 50 and clean the carriage system 100 in the cleaning step 60.

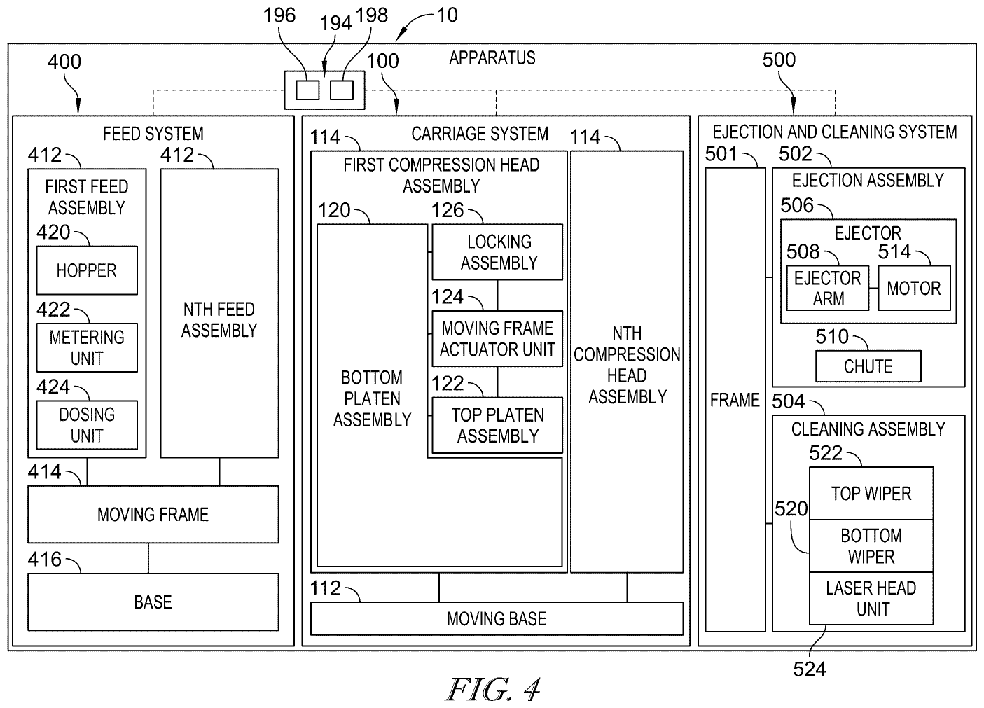

As depicted in FIGS. 1A and 4, the carriage system 100 includes at least one compression head assembly 114 (the carriage system 100 shown and described includes a plurality of compression head assemblies 114) configured to compress and heat the raw ingredients 12 to provide the expanded food product 14 and a moving base 112 coupled with the plurality of compression head assemblies 114. The moving base 112 moves the at least one compression head assembly 114 along a carriage path to facilitate the continuous process 20. In other embodiments, the moving base 112 is omitted and the at least one compression head assembly 114 is stationary relative to ground. Each compression head assembly 114 is adapted to receive the raw ingredients 12 from the feed system 400 and to compress, cook, and allow expansion of the raw ingredients 12 in the cooking step 40 to provide the expanded food product 14.

The carriage path 16 may form a closed loop or path of motion. In the illustrative embodiment, the carriage path 16 is a looped path. In the illustrative example, the looped path is a circular path that extends around an axis 102 extending vertical relative to ground. In other embodiments, the carriage path 16 is a closed path of motion (looped path) having any suitable shape including symmetrical and asymmetrical paths. In some embodiments, the carriage path 16 is looped and obround. In other embodiments, the carriage path 16 is not looped and components of the carriage system 100 move relative to other components of the carriage system 100, for example, along a linear path. In other embodiments, the apparatus 10 may not include a carriage system 100 and the compression head assemblies 114 may be stationary. In other embodiments, the carriage system 114 may not include the compression head assemblies 114, but may include other components such as the feed system 400, where the compression head assemblies 114 are stationary and the other components on the carriage system 100 move about the compression head assemblies 114.

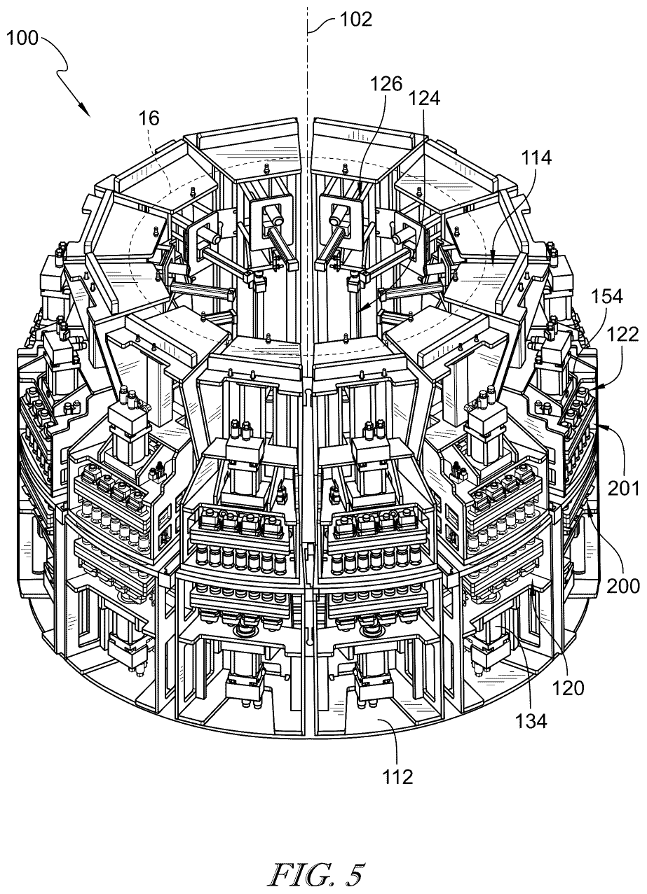

In the illustrative embodiment, the carriage system 100 includes a plurality of compression head assemblies. The carriage system 100 may include, for example, twelve compression head assemblies 114, compression head assembly 114A, 114B, 114C, 114D, 114E, 114F, 114G, 114H, 114I, 114J, 114K, 114L, in the illustrative embodiment as shown in FIG. 3. Each of the compression head assemblies 114 are substantially similar as suggested in FIGS. 1A and 5. As such, only one compression head assembly 114 is discussed in detail and such description applies to each of the compression head assemblies 114. In other embodiments, the carriage system 100 may include any suitable number of compression head assemblies 114.

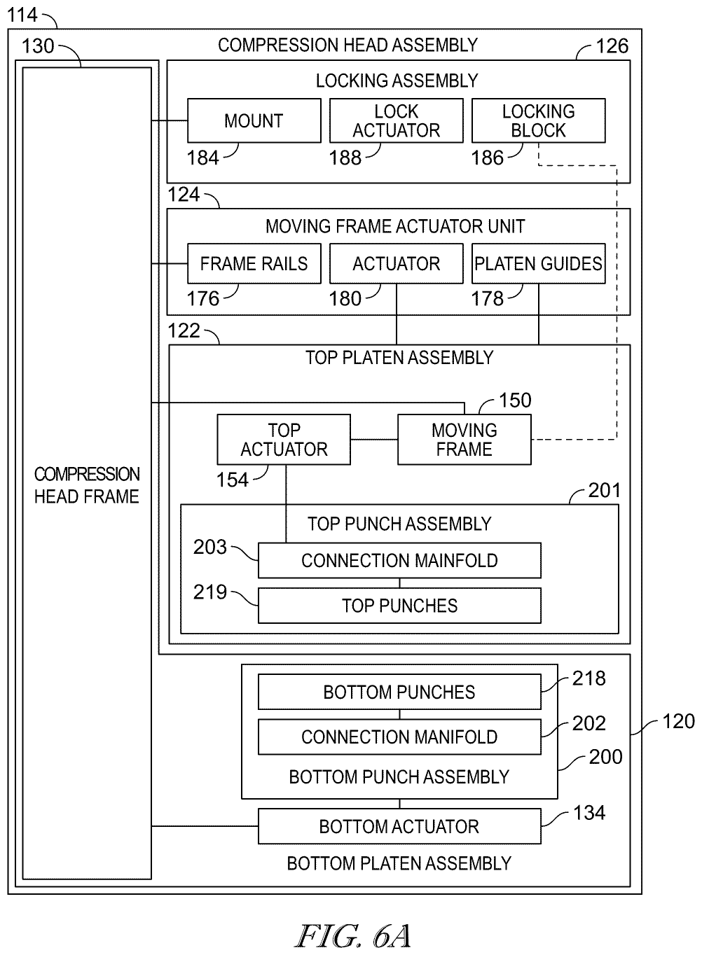

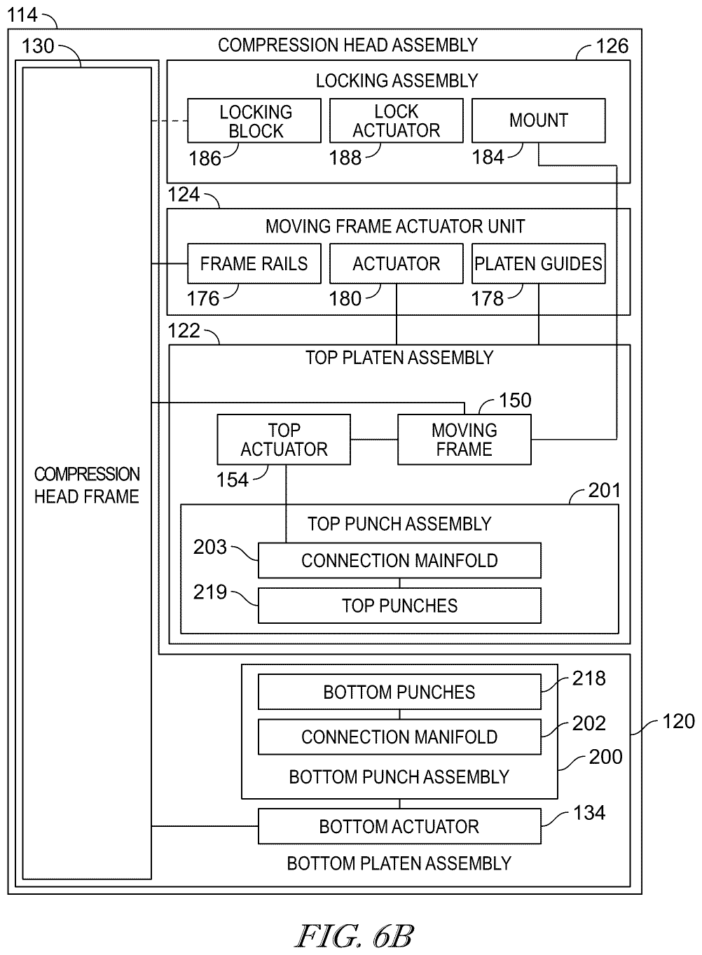

As depicted in FIGS. 5, 6A and 6B, the compression head assembly 114 includes a bottom platen assembly 120, a top platen assembly 122, a moving frame actuator unit 124, and a locking assembly 126. The bottom platen assembly 120 and the top platen assembly 122 cooperate to receive the raw ingredients 12 from the feed system 400 and compress, cook, and allow expansion of the raw ingredients 12 to provide the expanded food product 14 in the cooking step 40 of the process 20. As will be described in greater detail below, the moving frame actuator unit 124 and the locking assembly 126 cooperate to move and block movement, selectively, of the top platen assembly 122 relative to the bottom platen assembly 120 during the continuous process 20 to allow greater access between the bottom platen assembly 120 and the top platen assembly 122 for the cleaning step 60 of the process 20. In the illustrative embodiments, the compression head assemblies 114 are configured to act as a C-frame press, allowing for relatively greater accessibility between the top platen assembly 122 and the bottom platen assembly 120 than, for example, an H-frame press. The configuration of the C-frame shaped structure of the compression head assemblies 114 allow for different components of the apparatus 10 to move in and out from between the top platen assembly 122 and the bottom platen assembly 120 as discussed herein.

As depicted in FIGS. 6-9, the bottom platen assembly 120 includes a compression head frame 130, a bottom punch assembly 200, and a bottom actuator 134. The compression head frame 130 provides a rigid support structure for the compression head assembly 114. The bottom punch assembly 200 is configured to move relative to the compression head frame 130 and confront a top punch assembly 201 included in the top platen assembly 122 to compress, cook, and allow expansion of the raw ingredients 12 there between. The bottom actuator 134 is coupled with the compression head frame 130 and the bottom punch assembly 200 and configured to move selectively the bottom punch assembly 200 relative to the compression head frame 130.

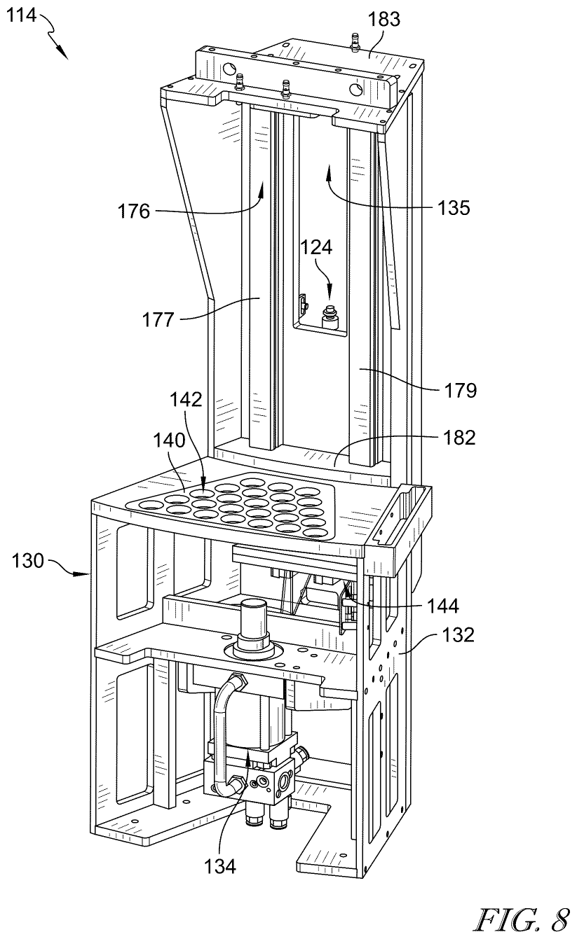

The compression head frame 130 includes a support frame 132 and a bottom ring plate 140 coupled with the support frame 132 as depicted in FIG. 8. The support frame 132 is coupled with the moving base 112 for movement along the carriage path 16. In other embodiments, the support frame 132 is supported on ground and the compression head assembly 114 is stationary. The support frame 132 includes a lower portion for receiving the bottom punch assembly 200 and the bottom actuator 134 and an upper portion that extends vertically away from the bottom portion for supporting the top platen assembly 122. The bottom ring plate 140 is coupled with the support frame 132 to form an upper wall of the lower portion of the support frame 132. The bottom ring plate 140 is formed to define at least one bottom ring hole 142 therein. Illustratively, the bottom ring plate 140 includes a plurality of bottom ring holes 142. In other embodiments, a single bottom ring hole 142 may be used such as, for example, to make a rice cake. The bottom ring holes 142 receive bottom punches 218 included in the bottom punch assembly 200 to guide movement of the bottom punches 218 as the bottom actuator 134 moves the bottom punch assembly 200 relative to the support frame 132 included in the compression head frame 130. The bottom ring plate 140 is fixed with the support frame 132. In other embodiments, the bottom ring plate 140 is movable vertically relative to the support frame 132 and the moving frame 150.

As depicted in FIG. 8, the compression head frame 130 may include an optional bottom air knife 144 coupled with the support frame 132. The bottom air knife 144 directs pressurized fluid, air for example from a pressurized fluid source, at the bottom punch assembly 200 to blow any uncooked raw ingredients 12, food product 14, or other debris away from the bottom punch assembly 200. The bottom air knife 144 may improve cleaning of the apparatus 10 and reduce or eliminate down time for service, repair, and cleaning of the apparatus 10.

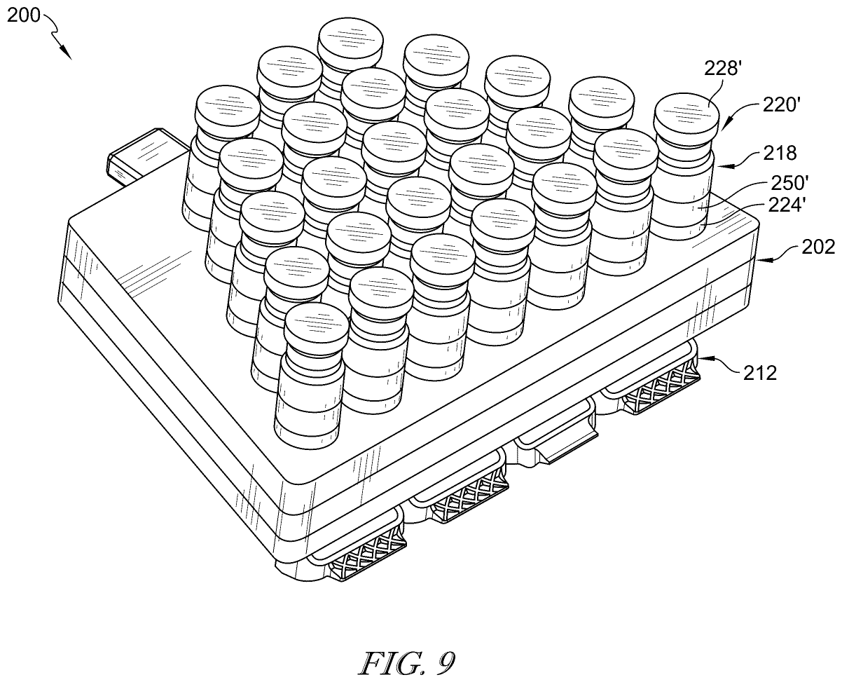

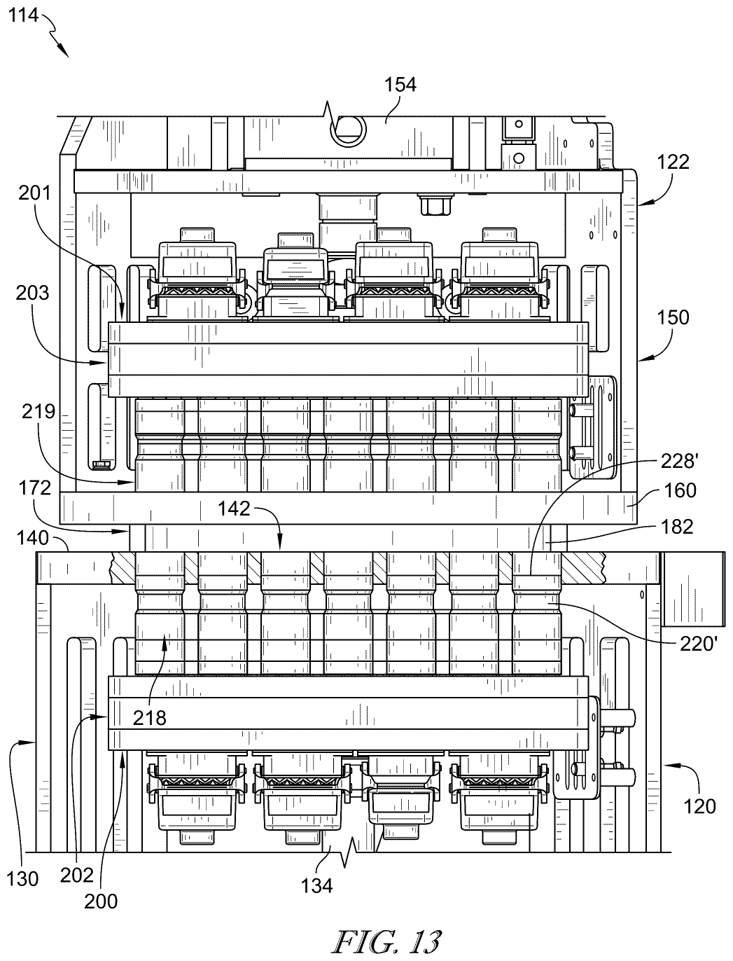

As depicted in FIG. 9, the bottom punch assembly 200 includes a connection manifold 202 and a plurality of bottom punches 218 that extend away from the connection manifold 202. The connection manifold 202 is coupled with the bottom actuator 134 and configured to be moved selectively by the bottom actuator 134 relative to the compression head frame 130 to move the plurality of bottom punches 218 in the corresponding plurality of bottom ring holes 142 as suggested in FIGS. 13-15. In the illustrative embodiment, the bottom actuator 134 translates the connection manifold 202 in a vertical direction. The plurality of bottom punches 218 are illustratively removably coupled with the connection manifold 202. In other embodiments, the plurality of bottom punches 218 are integrally formed with the connection manifold 202 as a single, one-piece component. In some embodiments, the bottom punch assembly 200 includes a single bottom punch 218 that extends into a single bottom ring hole 142.

In the illustrative embodiment, each of the plurality of bottom punches 218 is individually heated and temperature controlled. In other embodiments, all or groups of the plurality of bottom punches 218 are heated via heating of the connection manifold 202. In other embodiments, the plurality of bottom punches 218 may be grouped into zones and monitored by zone rather than individually. In the illustrative embodiment, the bottom punch assembly 200 further includes electrical connectors 212 for connecting heating elements and sensors with a controller 194. In some embodiments, groups of bottom punches 218 are heated based on a single temperature sensor located in one of the punches 218 or in the connection manifold 202.

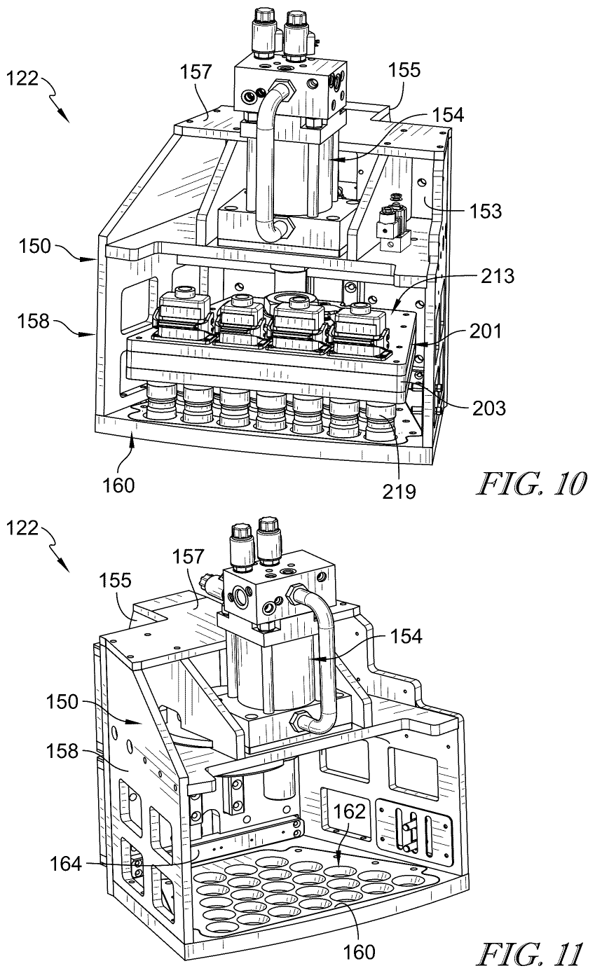

As depicted in FIGS. 10-12, the top platen assembly 122 includes a moving frame 150, a top punch assembly 201, and a top actuator 154. The moving frame 150 provides a rigid support structure that is movably coupled with the compression head frame 130. The top punch assembly 201 is configured to move relative to the moving frame 150 and confront the bottom punch assembly 200 included in the bottom platen assembly 120 to compress, cook, and allow expansion of the raw ingredients 12 there between. The top actuator 154 is coupled with the moving frame 150 and the top punch assembly 201 and configured to move selectively between an extended position and a retracted position to move the top punch assembly 201 relative to the moving frame 150.

The moving frame 150 includes a top platen carriage 158 and a top ring plate 160 coupled with the top platen carriage 158 as depicted in FIG. 11. The top platen carriage 158 is coupled with the compression head frame 130 for movement with the compression head frame 130 along the carriage path 16. The top ring plate 160 is coupled with the top platen carriage 158 to form a lower wall of the top platen carriage 158. The top ring plate 160 is formed to define a plurality of top ring holes 162 therein. The top ring holes 162 receive top punches 219 included in the top punch assembly 201 to guide movement of the top punches 219 as the top actuator 154 moves the top punch assembly 201 relative to the top platen carriage 158. In other embodiments, the top ring plate 160 is omitted and the top punches 219 are guided by the top actuator 154 and the bottom ring plate 140. In some embodiments, the top ring plate 160 includes a single top ring hole 162 and the top punch assembly 201 includes a single top punch 219.

The top platen carriage 158 illustratively includes a platen cage 153, a brace 155, and an upper plate 157 as depicted in FIGS. 10 and 11. The platen cage 153 houses the top punch assembly 201. The brace 155 extends from a back side of the platen cage 153 for attachment with a moving frame actuator 180. The upper plate 157 is coupled with an upper end of the platen cage 153 to react against the locking assembly 126.

As depicted in FIG. 11, the moving frame 150 may include an optional top air knife 164 coupled with the top platen carriage 158. The top air knife 164 directs pressurized fluid, air for example from the pressurized fluid source, at the top punch assembly 201 to blow any uncooked raw ingredients 12, food product 14, or other debris away from the top punch assembly 201. The top air knife 164 may improve cleaning of the apparatus 10 and reduce or eliminate down time for service, repair, and cleaning of the apparatus 10.

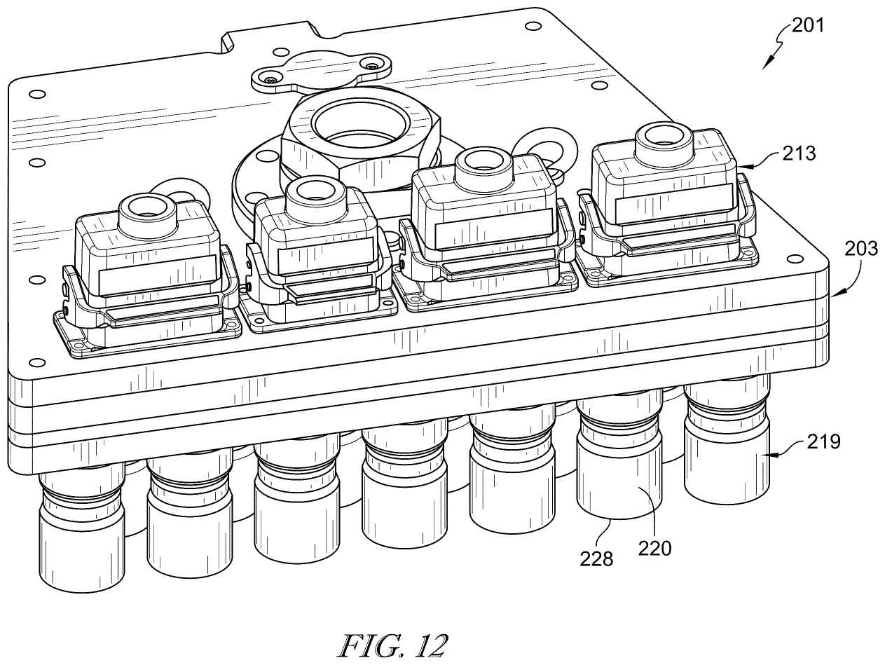

As depicted in FIG. 12, the top punch assembly 201 includes a connection manifold 203 and a plurality of top punches 219 that extend away from the connection manifold 203. The connection manifold 203 is coupled with the top actuator 154 and configured to be moved selectively by the top actuator 154 relative to the moving frame 150 to move the plurality of top punches 219 in the corresponding plurality of top ring holes 162 as well as the plurality of bottom ring holes 142 as suggested in FIGS. 13-15. In the illustrative embodiment, the top actuator 154 translates the connection manifold 203 in a vertical direction. The plurality of top punches 219 are illustratively removably coupled with the connection manifold 203. In other embodiments, the plurality of top punches 219 are integrally formed with the connection manifold 203 as a single, one-piece component. The illustrative top punch assembly 201 and the bottom punch assembly 200 allow for tolerances between the connection manifolds and the corresponding punches via kinematic mounting as discussed further below.

In the illustrative embodiment, each of the plurality of top punches 219 is individually heated and temperature controlled. In other embodiments, all or groups of the plurality of top punches 219 are heated via heating of the connection manifold 203. In other embodiments, the plurality of top punches 219 may be grouped into zones and monitored by zone rather than individually. In the illustrative embodiment, the top punch assembly 201 further includes electrical connectors 213 for connecting heating elements and sensors with the controller 194.

The bottom actuator 134 and the top actuator 154 are configured to move the bottom punch assembly 200 and the top punch assembly 201, respectively, between retracted and extended positions to allow the raw ingredients 12 to be fed into the compression head assembly 114 and compressed, cooked, and allowed to expand. In the illustrative embodiment, the bottom actuator 134 and the top actuator 154 are controlled to move to and between predetermined positions. In some embodiments, the predetermined positions may be adjusted manually or via software. In some embodiments, the bottom actuator 134, top actuator 154, and other actuators in the system are controlled to move for predetermined amounts of time.

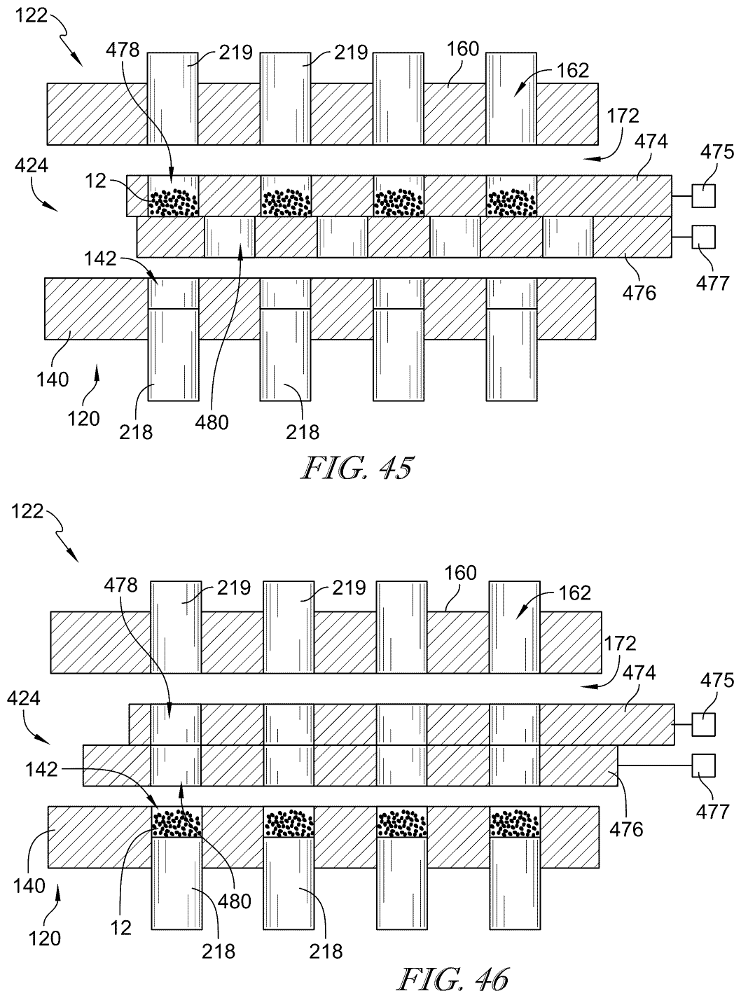

As suggested in FIGS. 13, 45, and 46, during operation of the compression head assembly 114 in the feeding step 30 of the process 20, the bottom actuator 134 is retracted to cause food contacting surfaces 228′ of the bottom punches 218 to be located in the respective bottom ring holes 142 to form a cavity for receiving the raw ingredients 12. The top actuator 154 is retracted to cause food contacting surfaces 228 of the top punches 219 to be spaced apart from the bottom ring plate 140 as shown in FIG. 13 to not obstruct a space 172 between the moving frame 150 and the compression head frame 130. The feed system 400 delivers the raw ingredients 12 into the cavity of each bottom ring hole 142 as discussed with reference to FIGS. 45 and 46.

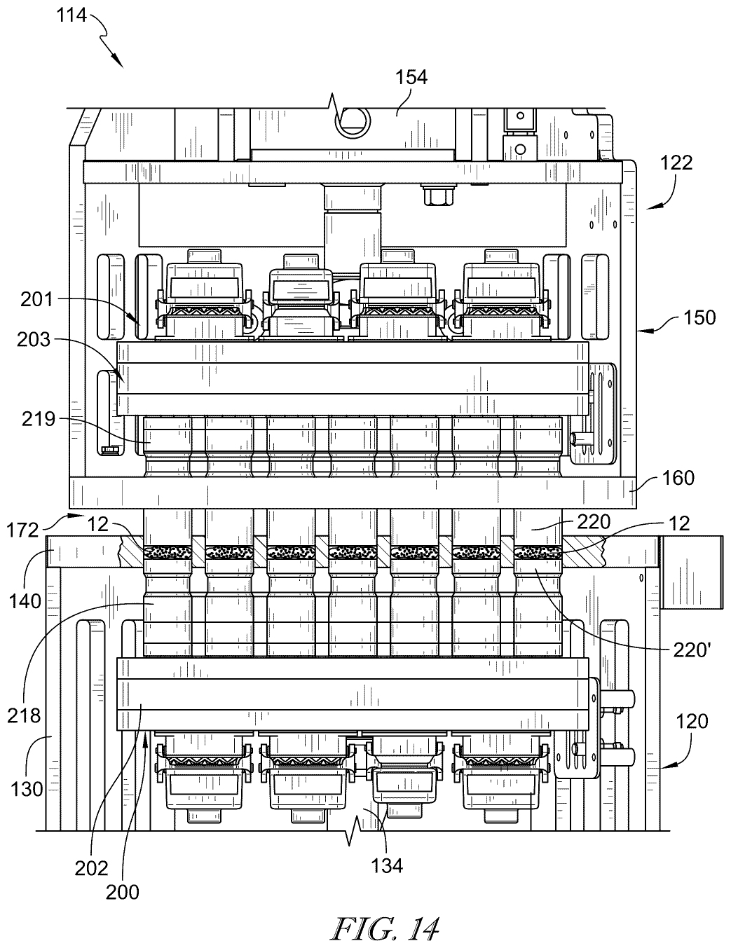

As depicted in FIG. 14, during the cooking step 40 of the process 20, the bottom actuator 134 extends to move the plurality of bottom punches 218 upward, but keeping the food contact surfaces 228′ within the respective bottom ring holes 142. In other embodiments, the bottom actuator 134 maintains its position or slightly retracts. The top actuator 154 extends to move the plurality of top punches 219 downward such that the food contact surfaces 228 of the top punches are located within the bottom ring holes 142 and cooperate with the bottom punches to compress and cook the raw ingredients 12.

As a result of the pressure and heat, the starch in the raw ingredients 12 are gelatinized, becomes amorphous, and moisture including chemically bound water of the raw ingredients 12 are driven off to build up a high internal vapor pressure. The built-up vapor pressure is then suddenly released by quickly retracting the bottom actuator 134 and/or the top actuator 154 relative to one another. As a result, the compressed raw ingredients 12 explosively expands to form the expanded food product 14, such as, for example, a puffed or popped wafer, filling the expansion chamber space defined in the bottom ring holes 142 between the top punch 219, the bottom punch 218, and the bottom ring plate 140. In some embodiments, the top actuator 154 and/or the bottom actuator 134 are partially or fully retracted, extended, and retracted in any suitable pattern during the cooking step 40 to control cooking temperature, shape, thickness, surface flatness, etc. of the food product 14. Optionally, the moving frame actuator 124 can be used to move the moving frame 150 selectively and thereby control and adjust a size of the expansion chamber space.

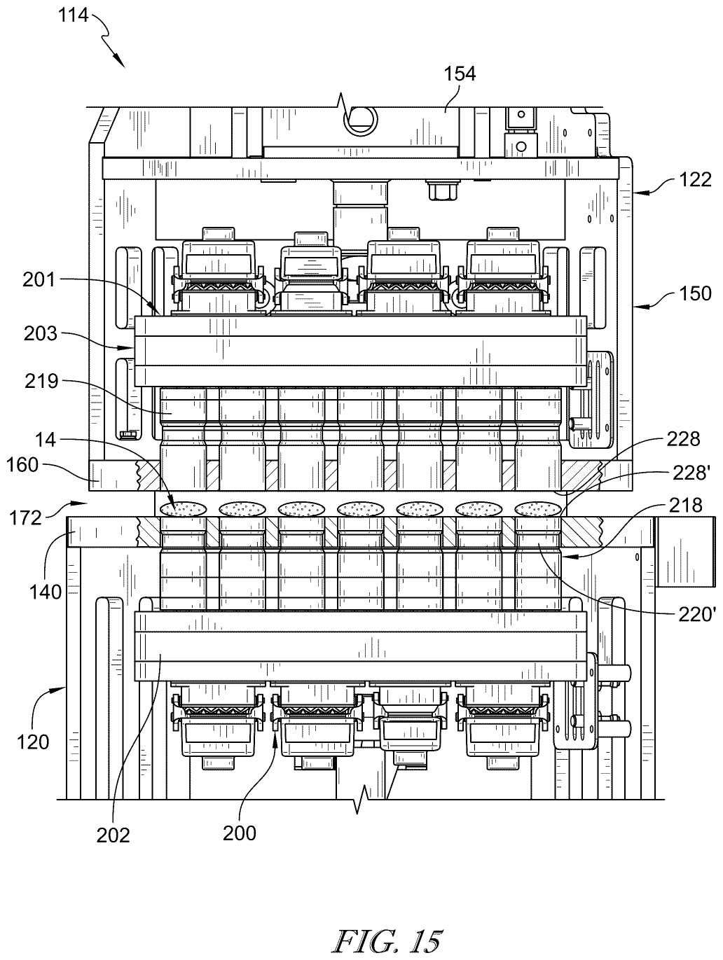

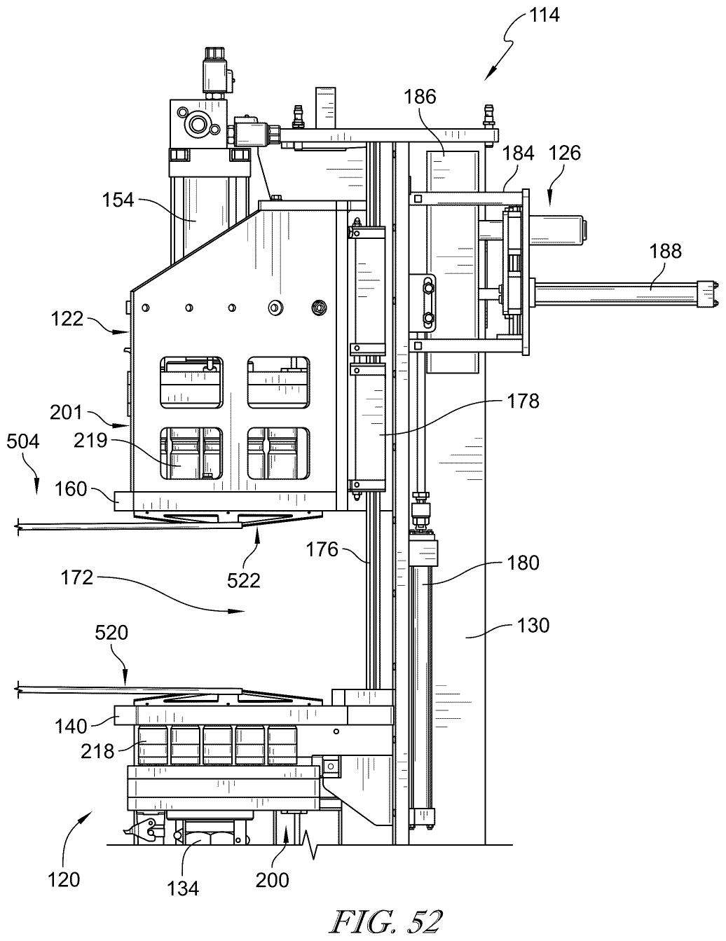

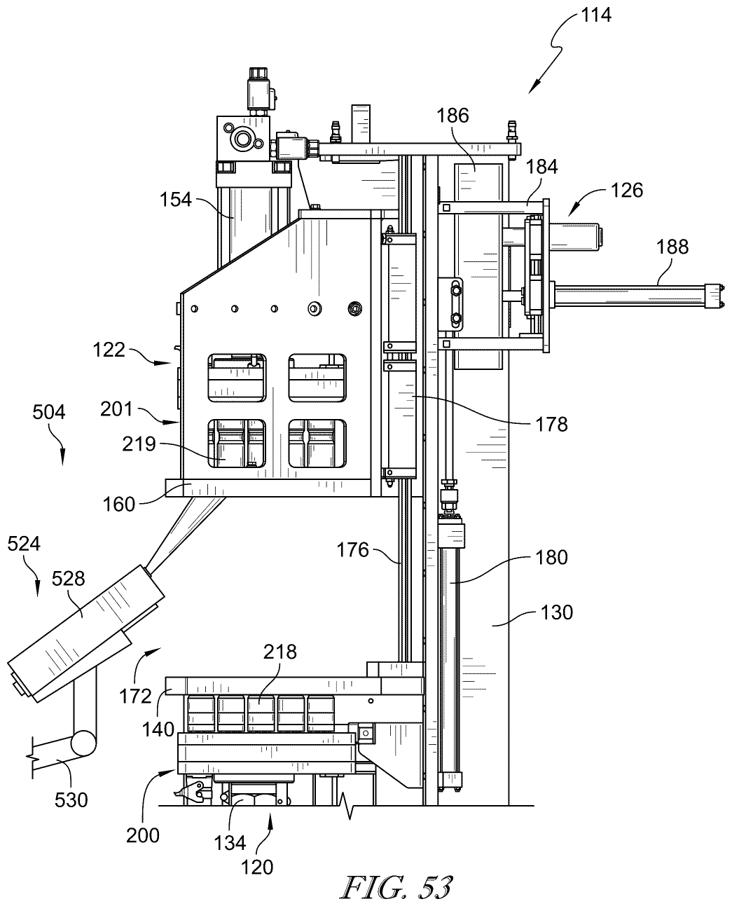

After the food product 14 is produced, the bottom actuator 134 extends to cause the food contact surface 228′ of the bottom punches 218 to be generally aligned and flush with an upper surface of the bottom ring plate 140 as depicted in FIG. 15 to assist in the removal of food products 14 and/or cleaning of the bottom platen assembly 120 during the ejection step 50 and the cleaning step 60 of the process 20. In the illustrative embodiment, the ejection and cleaning system 500 remove the food products 14 from the space 172 by contacting the food products 14 with an ejector arm 508 as suggested in FIGS. 2 and 3 and cleans the bottom ring plate 140 and the bottom punches 218 (food contacting surfaces 228, 228′) with a wiper 520 as the compression head assembly 114 moves along the carriage path 16 as depicted in FIG. 52. Optionally, a laser 528 directs a laser beam at the top ring plate 160 and/or bottom ring plate 140 and the food contacting surfaces 228, 228′ as depicted in FIG. 53.

The top actuator 154 retracts to move top punches 219 away from the bottom punches 218 in the ejection step 50 and the cleaning step 60. In the illustrative embodiment, the top actuator 154 moves the top punches 219 so that the food contacting surfaces 228 are generally aligned and flush with a lower surface of the top ring plate 160 as depicted in FIG. 15. In the illustrative embodiment, the ejection and cleaning system 500 clean the top ring plate 160 and the top punches 219 with a wiper 522 as the compression head assembly 114 moves along the carriage path 16 as depicted in FIG. 52. Optionally, the laser 528 directs a laser beam at the top ring plate 160 and the food contacting surfaces 228 of the top punches 219 as depicted in FIG. 53.

In conventional compression head assemblies, the maximum gap (similar to gap 172) between the top punches and the bottom punches is fixed and relatively small. The gap may be designed to be as small as possible and only as big as needed to allow a feeding tray to pass between the top punches and the bottom punches to deliver raw ingredients to the compression head before retracting and allowing the top and bottom punches to compress the raw ingredients. Because the size of such gap is relatively small and fixed in conventional assemblies, cleaning of the punch assemblies may be difficult. Typically, an operator shuts off the compression head assembly and uses one or more tools (picks, scrappers, etc.) to clean the assembly and scrape each of the punches, the bottom ring plate, or other surfaces of the assembly. To clean the top punches, a pick or other tool is inserted in the gap and the relatively small dimensions may limit the efficiency of the cleaning. Moreover, conventional assemblies do not include a top ring plate such that raw ingredients, food product, and other debris may more easily find its way onto the sidewalls of the top punches (where it may become overcooked and burned) and other areas within the assembly.

In illustrative embodiments, the present disclosure provides a compression head assembly 114 that includes the optional top ring plate 160 which receives the top punches 219 within the top ring holes 162 formed therein to prevent and limit ingress of the raw ingredients 12, food product 14, and other debris from moving onto the sidewalls of the top punches 219 or bottom surfaces of the connection manifold 203. Food build up and debris on the sidewalls of punches and other surfaces in conventional assemblies can cause issues such as falling into the food product and contaminating the food product, obstructing movement of the punches/components causing undesired cooking pressures, times, temperatures, sizes, etc. As a result of one or more features of the present disclosure, cleaning of the top punches 219 is minimized and any minimal debris may be ejected by the pressurized fluid of the top air knife 164.

The compression head assembly 114 of the present disclosure includes the moving frame 150 (compared to embodiments with a fixed frame 150). Such embodiments having the moving frame 150 further include a moving frame actuator unit 124 and locking assembly 126 which cooperate to move selectively the top platen assembly 122 away from the bottom platen assembly 120 to increase a size of the gap 172 and allow greater access for the cleaning step 60 and/or repair and maintenance. In other embodiments, the bottom platen assembly 120 moves away from the top platen assembly 122 or both assemblies 120, 122 move. Such movement and opening of the gap 172 is contrasted against conventional compression head assemblies in which the gap between platens is small and fixed as discussed above along with the difficulties that come with such small fixed sized gap.

The moving frame actuator unit 124 includes frame rails 176, platen guides 178, and a moving frame actuator 180 as shown in FIGS. 6, 8, and 16-20. The frame rails 176 are coupled with the compression head frame 130 as shown in FIG. 8 and provide a guided path for movement of the top platen assembly 122 relative to the bottom platen assembly 120. The platen guides 178 are coupled with the top platen assembly 122 and mate with the frame rails 176 to slide along the frame rails 176 when the top platen assembly 122 is moved. The moving frame actuator 180 is coupled with the compression head frame 130 and the top platen assembly 122 to move selectively the moving frame 150 of the top platen assembly 122 relative to the compression head frame 130.

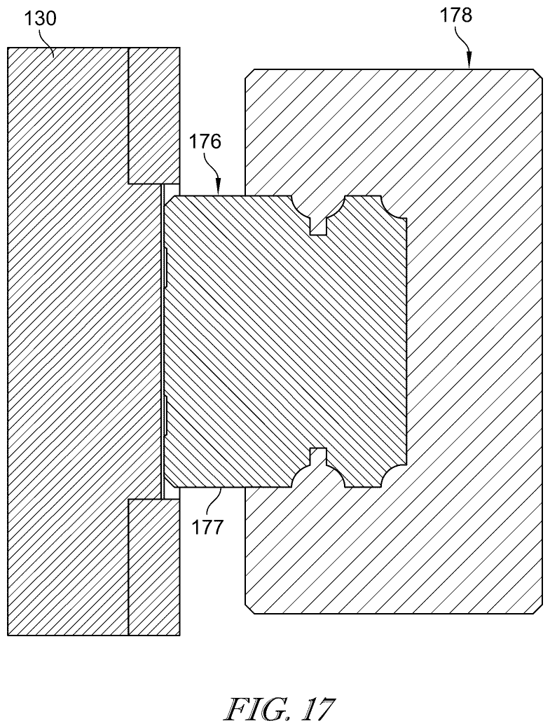

The frame rails 176 include a first frame rail 177 and a second frame rail 179 spaced apart from the first frame rail 177 as shown in FIG. 8. Illustratively, the frame rails 176 extend from a platen stop 182 of the compression head frame 130 to an upper cover plate 183 of the compression head assembly 114. In other embodiments, the frame rails 176 extend some height along the compression head frame 130. The platen stop 182 provides a surface that is vertically spaced apart from the bottom ring plate 140 and is configured to engage a lower surface of the moving frame 150 of the top platen assembly 122 to physically limit downward movement of the moving frame 150 beyond the platen stop 182 and thereby help provide the gap 172. Each of the first frame rail 177 and the second frame rail 179 are formed to include slots that run vertically on each side and receive mating features of the platen guides 178 as suggested in FIG. 17. In other embodiments, the platen guides 178 are formed to include slots. The structure of the compression head assemblies 114, including the dual frame rails 177, 179 as well as other reinforcements and structures such as the cover plate 183, contribute to the stiffness of the assemblies 114. The rigidity and stiffness of the assemblies 114 help to keep the plates 140, 160 parallel during the compression cycle and resist non-axial forces.

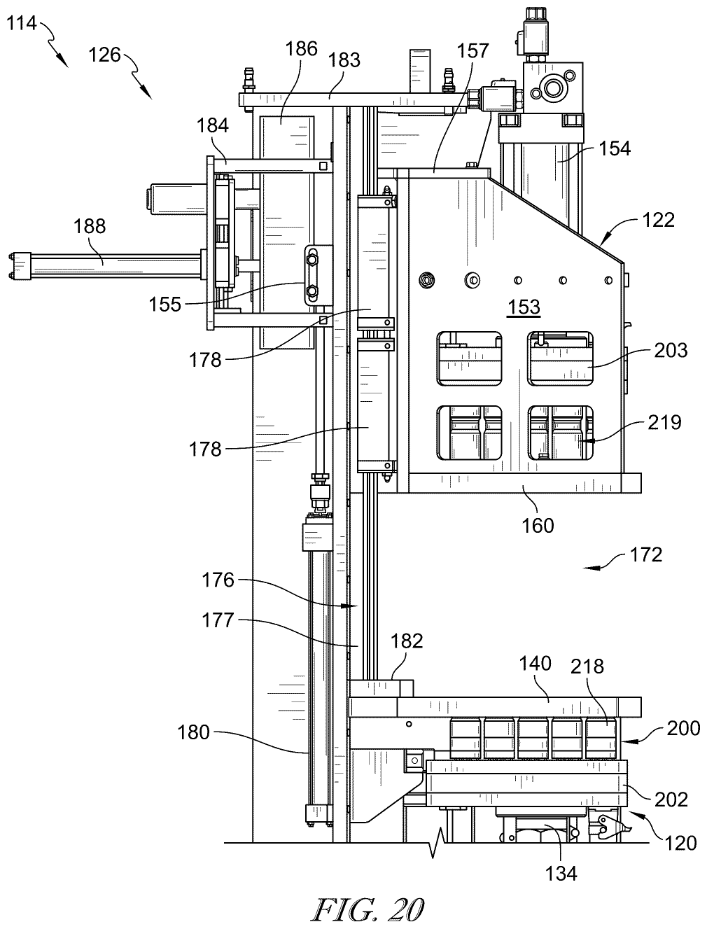

The platen guides 178 are coupled to a back side of the moving frame 150 as shown in FIG. 20. In the illustrative embodiment, the platen guides 178 include four platen guides. Two platen guides 178 are located vertically above one another on each lateral side of the moving frame 150. The platen guides 178 include a body and tabs that extend away from the body and into the slots of the frame rails 176. The platen guides 178 slide in a translating motion along the frame rails 176 to move the moving frame 150 vertically relative to the compression head frame 130 and thereby relative to the bottom platen assembly 120.

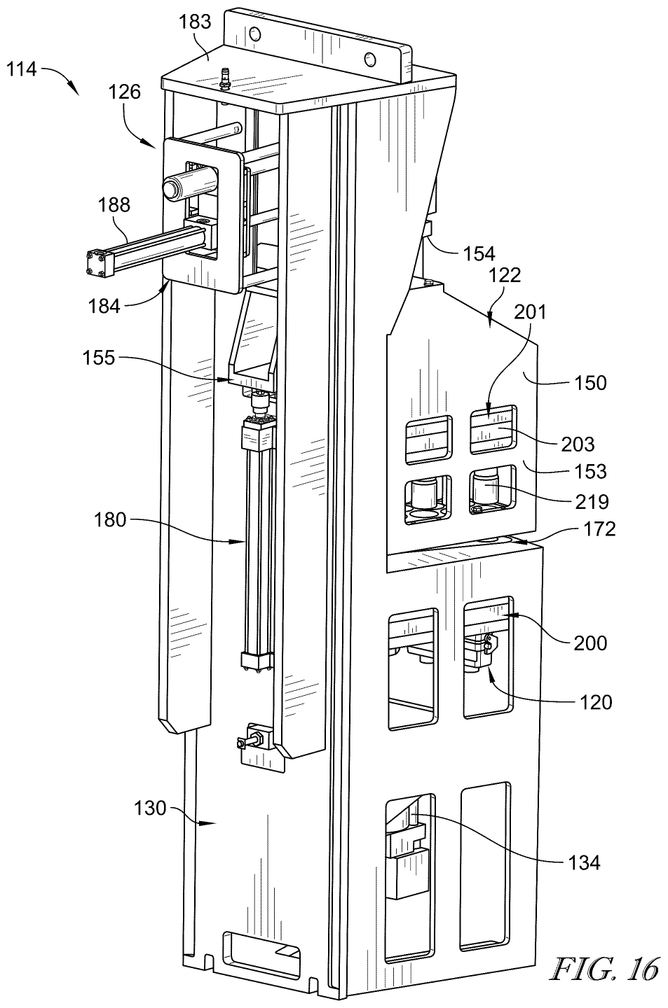

The moving frame actuator 180 is coupled with a back side of the compression head frame 130 as depicted in FIG. 16. The moving end of an actuator rod included in the moving frame actuator 180 is coupled to the moving frame 150. In the illustrative embodiment, the top platen carriage 158 of the moving frame 150 includes the platen cage 153 and the brace 155 that extends away from the platen cage 153. The moving frame actuator 180 is coupled with the brace 155 and applies selectively a force to the brace 155 to raise and lower the top platen assembly 122. As shown in FIGS. 8 and 16, the brace 155 is received in a cutout 135 formed in the compression head frame 130 so as to not obstruct movement of the brace 155 and the top platen assembly 122 when being moved by the moving frame actuator 180.

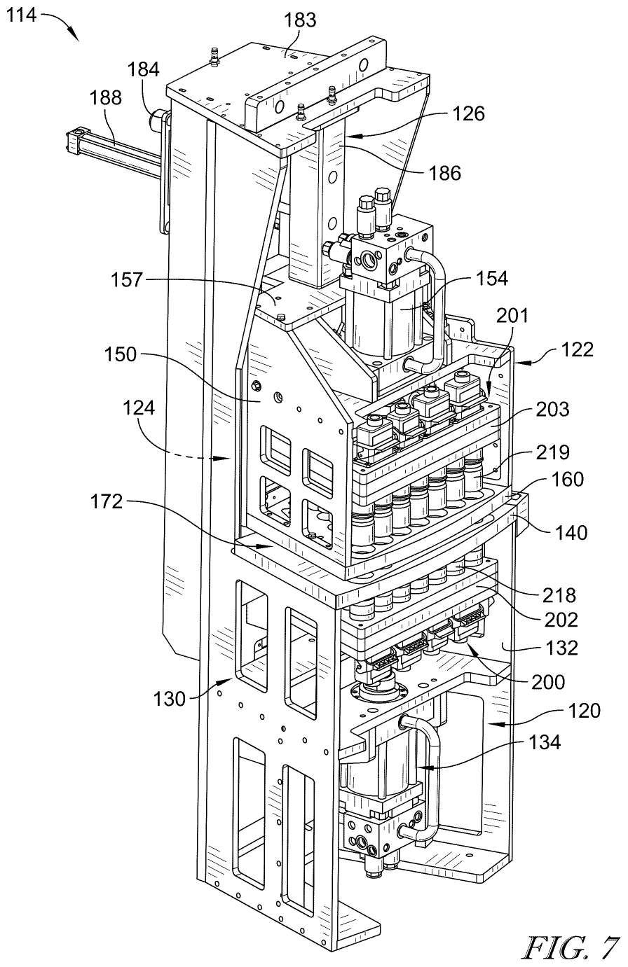

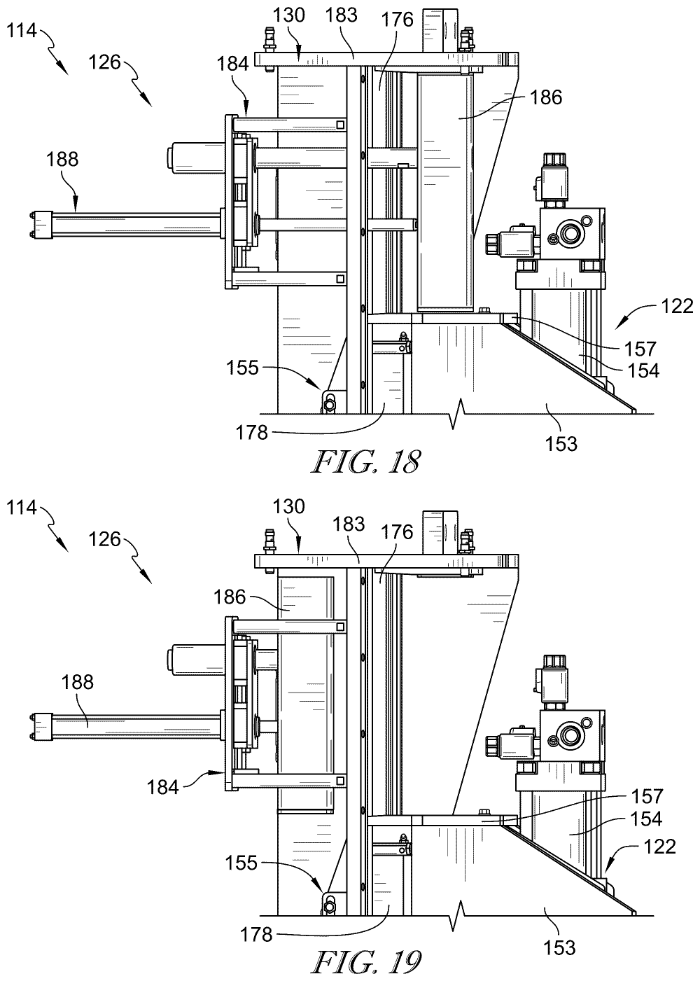

The locking assembly 126 is movable between a locked position, as depicted in FIGS. 7 and 18, and an unlocked position, as depicted in FIGS. 19 and 20. In the locked position, the locking assembly engages the top platen assembly 122 to block the top platen assembly from moving (via the moving frame actuator unit 124) relative to the compression head frame 130. The locked position maintains the top platen assembly 122 in place during the cooking step 40 and resists the upward force caused by the top actuator 154 pushing the top punches 219 into compression against the raw ingredients 12 and the bottom punches 218. In the unlocked position, the locking assembly 126 is spaced apart or otherwise not engaged with the top platen assembly 122 to allow the top platen assembly 122 to be moved by the moving frame actuator unit 124 as suggested in FIGS. 19 and 20. As such, the top platen assembly 122 may be moved away from the bottom platen assembly 120 during the cleaning step 60.

The locking assembly 126 includes a mount 184, a locking block 186, and a lock actuator 188 as depicted in FIGS. 18-20. As shown in FIG. 6A, the mount 184 is coupled with the back side of the compression head frame 130. In other embodiments, as shown in FIG. 6B, the mount 184 is alternatively coupled with the moving frame 150. In the illustrative embodiment, the mount 184 includes a plate and a plurality of support members that extend from the plate and couple with the compression head frame 130 to space apart the plate from the compression head frame 130 and provide room for the lock actuator 188 and the locking block 186. The locking block 186 is a rigid member configured to physically block movement of the top platen assembly 122. The illustrative locking block 186 is a cuboid that has a height sized to cause the locking block 186 to engage the upper cover plate 183 of the compression head frame 130 and the upper plate 157 of the moving frame 150 as depicted in FIGS. 6A and 18. In some embodiments, as shown in FIG. 6B, where the mount 184 is coupled with the moving frame 150, the locking block engages the head frame 130. In other embodiments, the locking block 186 may be a cylinder or any other suitable shape and may engage other surfaces of the compression head assembly 114 to block selectively movement of the top platen assembly 122.

The lock actuator 188 is coupled with the mount 184 and the locking block 186 and configured to move between an extended position and a retracted position. In the extended position, the locking block 186 is engaged with the compression head frame 130 and the top platen assembly 122 such that the locking assembly 126 is in the locked position as depicted in FIG. 19. In the retracted position, the locking block 186 is spaced apart from the top platen assembly 122 such that the locking assembly 126 is in the unlocked position as depicted in FIGS. 19 and 20. As shown in FIG. 19, in the unlocked position, the locking block 186 is moved through the cutout 135 in the compression head frame 130 to a space defined by the mount 184 behind the compression head frame 130.

During the operation of method 20, each of the compression head assemblies 114 are actuated in a synchronized pattern for the feeding step 30, the cooking step 40, the ejection step 50, and the cleaning step 60. The carriage system 100 includes the controller 194 having a processor 196, and a memory 198 having stored thereon instructions that are executed by the processor 196 to control the actuators, heating elements, and other electrically controlled devices. The controller 194 may be included in a single or multi-controller system for the food making apparatus 10. The controller 194 is programmed to perform and control the operation of the apparatus 10. In the illustrative embodiment, each of the steps are performed with the carriage system 100 moving without pauses.

For the feeding step 30 of a given compression head assembly 114, the top platen assembly 122 is in the lowered position, the locking assembly 126 is in the locked position, and the bottom punch assembly 200 and top punch assembly 201 are spaced apart so that the gap 172 is unobstructed as depicted in FIGS. 7 and 13. The feed system 400 moves into the gap 172 and doses a predetermined amount of raw ingredients 12 into each of the bottom ring holes 142 and then moves out of the gap 172 as suggested in FIGS. 45 and 46. The controller 194 is configured to operate the compression head assemblies 114 in the feed mode. In some embodiments, of the feeding step 30, the top platen assembly 122 is moved to an intermediate position between the raised and lowered positions, the locking assembly 126 is in the unlocked position, and the bottom punch assembly 200 and top punch assembly 201 are spaced apart so that the gap 172 is unobstructed. The raised and lowered positions may be, for example, at least 200 mm apart. In some embodiments, the raised and lowered positions may be 500 mm apart.

In particular, the moving frame actuator 180 is retracted so that the top platen assembly 122 is in the lowered position. In the illustrative embodiment, the top platen assembly 122 is engaged with the platen stop 182. The lock actuator 188 is extend so that the locking assembly 126 is in the locked position with the locking block 186 engaged with the upper plate 157 of the moving frame 150 and the upper plate 183 of the compression head frame 130. In other embodiments, the top platen assembly 122 is in the intermediate position and spaced apart from the platen stop 182 and the locking block 186 is not engaged with the upper plate 157. The bottom actuator 134 is retracted at least to cause a space to form in the bottom ring holes 142 between the bottom ring plate 140 and the bottom punches 218. The top actuator 154 is retracted at least to cause the top punches 219 to not obstruct the gap 172. The top punches 219 may be entirely located out of the gap 172.

For the cooking step 40 of a given compression head assembly 114, the top platen assembly 122 is in the lowered position, the locking assembly 126 is in the locked position, and the bottom punch assembly 200 and top punch assembly 201 are moved toward each other as depicted in FIG. 14. The controller 194 is configured to operate the compression head assemblies 114 in a cook mode. In particular, the moving frame actuator 180 is retracted so that the top platen assembly 122 is in the lowered position. In the illustrative embodiment, the top platen assembly 122 is engaged with the platen stop 182. The lock actuator 188 is extend so that the locking assembly 126 is in the locked position with the locking block 186 engaged with the upper plate 157 of the moving frame 150 and the cover plate 183 of the compression head frame 130. Movement of the moving frame 150 relative to the compression head frame 130 is blocked during the cooking step 40.

The top actuator 154 extends to cause the top punches 219 to extend through the top ring plate 160 and into the bottom ring holes 142. The bottom actuator 134 extends to move the bottom punches 218 toward the top punches 219, but keeping cooking surfaces 228′ of the bottom punches within the bottom ring holes 142 so that the raw ingredients 12 remains in the bottom ring holes 142. As a result, the raw ingredients 12 are compressed and heated in each bottom ring hole 142 of the bottom ring plate 140 between a bottom punch 218 and a top punch 219 to cook the raw ingredients 12 into the food product 14. The top actuator 154 and bottom actuator 134 may be programmed with any suitable combination movement or timing instructions to cause the top punches 219 and bottom punches 218 to compress and heat the raw ingredients 12.

The raw ingredients 12 are compressed by moving either or both the plurality of bottom punches 218 relative to the compression head frame 130 and the plurality of top punches 219 relative to the moving frame 150. The plurality of top punches 219 are translated in the corresponding plurality of top ring holes 162 formed in the top ring plate 160 and into the plurality of bottom ring holes 142 formed in the bottom ring plate 140. In some embodiments, the top ring plate 160 is omitted. The plurality of bottom punches 218 are translated partway into the plurality of bottom ring holes 142. The raw ingredients 12 are cooked with the bottom punches 218 and the top punches 219 while the raw ingredients 12 are compressed, contained, released (and any suitable combinations thereof) to provide the food product 14. As discussed above, a single bottom punch 218 and a single top punch 219 may be used in the compression head assembly 114 to form a single food product 14.

The controller 194 may instruct the bottom actuator 134 and the top actuator 154 to retract and extend one or more times over preset periods of time to obtain a desired cook time, internal temperature, surface texture, etc. of the food product 14. To give some examples, during portions of the cook cycle the raw ingredients 12 may be compressed (i.e. force applied by the punches 218, 219 to the raw ingredients 12), contained (i.e. punches 218, 219 are held in position and resisting the vapor pressure inside the cook chamber from the steam generated by heating the raw ingredients 12 without applying compressive force to the raw ingredients 12), or released (i.e. punches 218, 219 move away from the raw ingredients 12 to increase the volume of the cooking chamber to allow the raw ingredients 12 to expand and/or allowing more volume for superheated liquid water in the raw ingredients 12 to change phase into steam). In some embodiments, the bottom actuator 134 does not move during the cooking step 40 and remains at least partially retracted. In some embodiments, the bottom punches 218 and the top punches 219 are maintained within the bottom ring holes 142. In some embodiments, either or both the bottom punches 218 and the top punches 219 are allowed to move outside of the bottom ring holes 142.

In the illustrative example, the controller 194 (via the processor and memory) calculates a speed of the compression head assembly 114 along the carriage path 16. The speed may be an angular speed (angle/rad/rotations per second) or a linear speed (distance per second). The controller 194 generates an activation schedule based on the speed and a predetermined timing schedule stored in the memory. The timing schedule includes periods of times to retract and extend one or more of the actuators 134, 154 for cooking the raw ingredients 12. For example, one recipe may include a predetermined timing schedule to extend the top actuator 154 for 500 milliseconds (to compress and cook), hold for 500 milliseconds, and retract for 500 milliseconds. The activation schedule is generated by using the speed of the compression head assembly 114 and the predetermined timing schedule. In this example, if the path 16 is circular and the speed is 20 degrees per second, the activation schedule would be extend the top actuator for 10 degrees, hold for 10 degrees, and retract for 10 degrees of movement of the compression head assembly 114. In this way, the cooking step 40 may be initiated at a set position along the carriage path (for example, at 135 degrees relative to the 0 degree datum) and then the movement of the actuators 134, 154 is controlled based on the position of the compression head assembly 114 along the carriage path (in this example, at 135 degrees, 145 degrees, and 155 degrees).

Such a timing control method may provide improved control of the cooking step. In conventional systems, a programmable logic controller (plc) or other controller may control the overall apparatus and store or calculate cooking times and transmit the control instructions to other controllers for operating the actuators. A significant lag time can occur based on the scan rate of the programmable logic controller and lag in communicating to the other controllers. In the present disclosure, a programmable logic controller may send the predetermined timing schedule to the controller 194 or the controller 194 may otherwise store the predetermined timing schedule. The controller 194 may then carryout the control logic above to control cook time via position of the compression head assembly 114 independent of the scan time or lag of such programmable logic controller

For the ejection step 50 of a given compression head assembly 114, the top platen assembly 122 may be in the lowered position and the locking assembly 126 may be in the locked position. The controller 194 is configured to operate the compression head assemblies 114 in an eject mode. In some embodiments, the top platen assembly 122 may be in the raised position and the locking assembly 126 may be in the unlocked position. The top actuator 154 retracts and moves the top punch assembly 201 upwardly so that the top punches 219 do not obstruct the gap 172. Illustratively, the top punches 219 are out of the gap 172 and the cooking surfaces 228 of the top punches 219 are generally aligned with and flush with the bottom surface of the top ring plate 160 as depicted in FIG. 15.

The bottom actuator 134 moves the bottom punch assembly 200 upwardly so that the cooking surfaces 228′ of the bottom punches 218 are generally aligned with or flush with the upper surface of the bottom ring plate 140 as depicted in FIG. 15. As a result, the food products 14 are supported on the cooking surfaces 228′ of the bottom punches 218 and may slide along the bottom ring plate 140 or otherwise moved out of the gap 172 by the ejection assembly 502.

For the cleaning step 60 of a given compression head assembly 114, the plurality of top punches 219 and the moving frame 150 are moved away from the plurality of bottom punches 218 and the compression head frame 130 to increase a size of the gap 172 and improve access to the top plurality of punches 219 and the bottom plurality of punches 218. The controller 194 is configured to operate the compression head assemblies 114 in a clean mode. In particular, the top platen assembly 122 is moved to the raised position so that a size of the gap 172 is increased, the locking assembly 126 is in the unlocked position as depicted in FIGS. 19 and 20. The moving frame actuator 180 is extended so that the top platen assembly 122 is in the raised position. The lock actuator 188 is retracted so that the locking assembly 126 is in the unlocked position with the locking block 186 moved away from the upper plate 157 of the moving frame 150 and the upper plate 183 of the compression head frame 130 as depicted in FIG. 19 to allow the plurality of top punches 219 and moving frame 150 to be moved away from the plurality of bottom punches 218 and the compression head frame 130.

In the clean mode, the top actuator 154 is retracted to translate the top punches 219 so that the food contact surfaces 228 of the top punches 219 are generally aligned with and flush with the bottom surface of the top ring plate 160 as depicted in FIG. 15. The bottom actuator 134 is extended to translate the bottom punches 218 so that the food contact surfaces 228′ of the bottom punches 218 are generally aligned with or flush with the upper surface of the bottom ring plate 140 as depicted in FIG. 15. As such, the food contact surfaces 228 of the top punches 219 are flush with the surface of the top ring plate 160 and the food contact surfaces 228′ of the bottom punches 218 are flush with the surface of the bottom ring plate 140 at a time when the moving frame 150 is raised and moved away from the compression head frame 130.

By moving the top platen assembly 122 to the raised position, the size of the gap 172 is increased to allow increased access for cleaning the bottom platen assembly 120 and the top platen assembly 122 in the cleaning step 60. The bottom punches 218 and the top punches 219 have surfaces flush with the bottom ring plate 140 and top ring plate 160, respectively, so that generally continuous surfaces are exposed for cleaning. In the illustrative embodiment, wipers 520, 522 contact the bottom ring plate 140 and the top ring plate 160 to scrape debris from the bottom punches 218, the bottom ring plate 140, the top punches 219, and the top ring plate 160 as suggested in FIG. 52.

The cleaning assembly 504 may further include the optional laser head unit 524 that directs a laser beam onto the bottom punches 218, the bottom ring plate 140, the top punches 219, and the top ring plate 160 to burn away and remove debris as suggested in FIG. 53. Illustratively, the laser head unit 524 is located downstream of the wipers 520, 522 so that a majority of the debris is removed by the wipers 520, 522 and less or no debris remains for the laser beam to remove.

The cleaning step 60 may be performed during the continuous movement of the carriage system 100 as described above or performed while the carriage system 100 is shut down and not operating to cook food product 14. Performing the cleaning step 60 during operation and continuous movement of the carriage system 100 may provide increased efficiency and more food product 14 being produced while minimizing downtime. Even still, the assembly may be shut down and any number of the top platen assemblies 122 raised to allow for detailed cleaning and/or maintenance and repair.

After the cleaning step 60 of a given compression head assembly 114, the controller 194 generates instructions to move the actuators 134, 154, 180, 188 to return the compression head assembly 114 to a position for the feeding step 30 and the cycle is repeated. In some embodiments for the feeding step, the top platen assembly 122 is in the intermediate position, the locking assembly 126 is in the unlocked position, and the bottom punch assembly 200 and top punch assembly 201 are spaced apart so that the gap 172 is unobstructed. At least in time for the cooking step 40, the top platen assembly 122 is in the lowered position, the locking assembly 126 is in the locked position, and the bottom punch assembly 200 and top punch assembly 201 are spaced apart so that the gap 172 is unobstructed as depicted in FIGS. 7 and 13.

Referring again to FIGS. 9 and 12, the bottom punch plate assembly 200 and the top punch plate assembly 201 of the present disclosure are multi-piece components that assist in alignment of the bottom punches 218 with the bottom ring holes 142 and the top punches 219 with the top ring holes 162. Moreover, the punches 218, 219 include individual heating elements to more precisely control the cooking temperature of each food product 14. In some embodiments, the punches 218, 219 are individually controlled to be at different temperatures, for example, if the punches 218, 219 are cooking are different raw ingredients 12 and/or forming different food products. In some embodiments, the controller 194 can detect when a heater 222, 222′ within a punch 218, 219 fails, and can adjust the heaters 222, 222′ of the surrounding punches 218, 219 to compensate for the failed heater 222, 222′. The features described may provide the benefits as herein described. However, the features are optional and, in other embodiments of the compression head assemblies 114, one or both of the bottom punch plate assembly 200 and the top punch plate assembly 201 and/or the punches 218, 219 may be conventional components.

In conventional compression head assemblies, a single or plurality of metal punches are integral with or otherwise fixed with a metal plate. The metal plate is heated at one or several locations and the heat is conducted throughout the metal plate and into the single or plurality of punches. As a result, the heat may not be distributed uniformly causing some punches to be hotter or cooler than others and the punch assembly to have non-uniform thermal growth.

Because the conventional punches are integral or fixed and the assembly does not experience uniform thermal growth, the punches may move relative to the bottom ring holes in the bottom ring plate. As an example, one or more of the top punches may not align with the bottom ring holes if the non-uniformity is too great such that the top punch assembly engages the bottom ring plate upper surface and cannot interact with the raw ingredients and bottom punches in the bottom ring holes. To overcome this difficulty, the conventional punches are matched to a specific machine and are not swappable with other compression head assemblies. In other conventional punches, the clearance tolerances are large such that the space between punches and rings are large to accommodate thermal growth. Such large spacing may allow for undesirable steam and food material to escape and may result in inefficient cooking. Additionally, the punch assemblies may be heated only when trapped in the holes so that the punches cannot misalign with the holes due to thermal growth. The non-uniform temperature gradient in conventional punch assemblies may also result in some punches cooking raw ingredients at a higher temperature than other punches of the same machine such that the food products made by the machine are not consistent (some overcooked, some undercooked, etc.). The punch plate assemblies 200, 201 of the present disclosure may alleviate or eliminate the problems of the conventional assemblies.

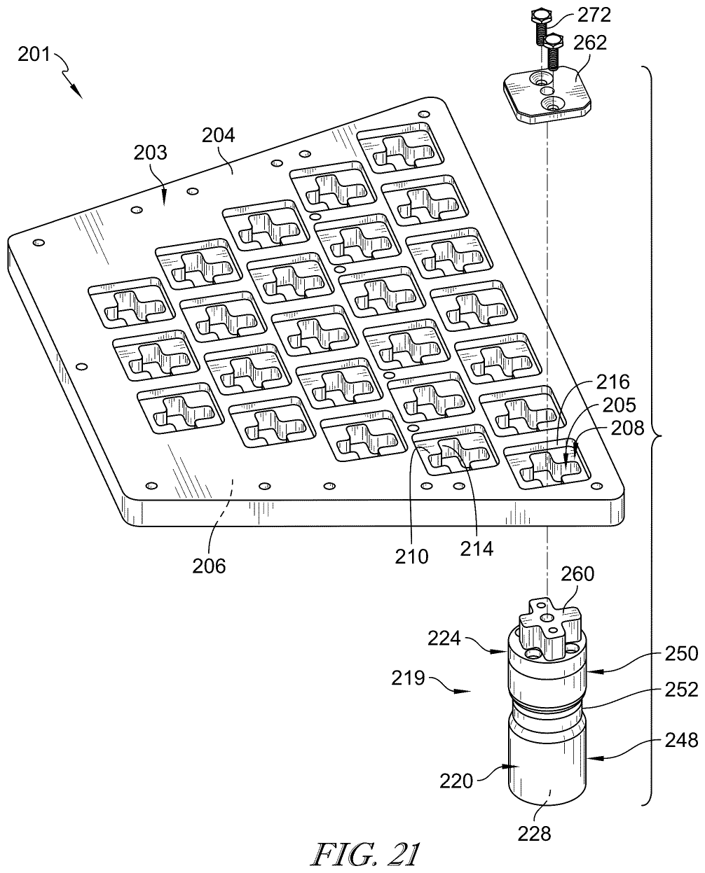

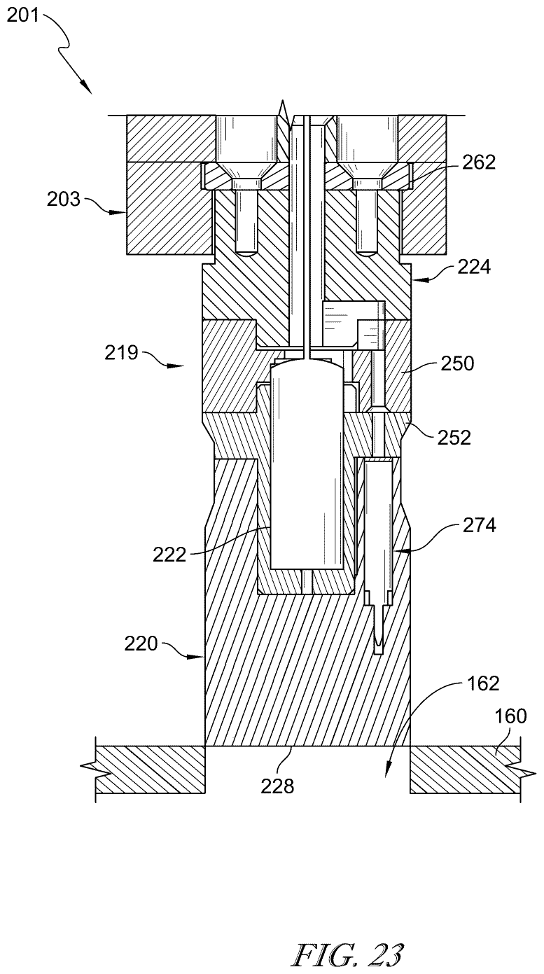

The top punch plate assembly 201 includes the connection manifold 203 and the plurality of top punches 219 as depicted in FIG. 12. An exploded view of the connection manifold 203 and one of the top punches 219 is depicted in FIG. 21. The bottom punch plate assembly 200 is substantially similar to the top punch plate assembly 201 and is, therefore, not discussed in detail. The connection manifold 203 is formed to include a plurality of slots 205 that extend axially through the connection manifold 203. Each top punch 219 is received in a corresponding slot 205 and coupled with the connection manifold 203. Each slot 205 is sized to form a gap between the top punch 219 and a sidewall of the connection manifold. The top punch 219 is interlocked with the connection manifold 203 to be blocked from vertical movement, but is otherwise free to move in the slot 205 in the horizontal plane by a limited amount to allow for thermal growth of the top punches 219, ring plates 160, 162, and connection manifold 203 so that each top punch 219 may align with the corresponding top ring hole 162 (and/or bottom ring hole 142 if the top ring plate 160 is omitted) as suggested in FIG. 23. The top ring plate 160 and the bottom ring plate 140 may be formed with tapered or chamfered edges for the holes 162, 142 to guide and align the punches 218, 219 into the holes 162, 142. The description herein may also be applied to manifolds 202, 203 having a single punch 218, 219.

The connection manifold 203 has an outer surface 204 and an inner surface 206 spaced apart from the outer surface 204. The connection manifold 203 is further formed to include a plurality of pockets 208 that extend through the outer surface 204 and partway into the connection manifold 203 to an interior surface 210. Each slot 205 extends through the interior surface 210 in each corresponding pocket 208 and through the inner surface 206. In other embodiments, the pockets 208 may be omitted and the slots 205 extend through the outer surface 204 and the inner surface 206. Each pocket 208 is defined by the interior surface 210 and a sidewall 216 that extends between the outer surface 204 and the interior surface 210. The pockets 208 are rectangular in the illustrative embodiment, but may be any suitable shape.

Each slot 205 is defined by a sidewall 214 of the connection manifold that extends between and interconnects the inner surface 206 and the interior surface 210. Each of the slots 205 has a negative contour such as a cross, rectangle, square, triangle, unique shape, etc. In the illustrative embodiment, the negative contour is non-circular so that the sidewall 214 limits rotation of the top punch 219 relative to the connection manifold 203.

Each top punch 219 includes a cook block 220, a heater 222, and a connection block 224 as shown in FIG. 23-25. The cook block 220 is arranged to contact the raw ingredients 12 and apply the compressive force and heat to the raw ingredients 12 to make the expanded food product 14 upon release of the compressive force. The heater 222 is located within the top punch 219 and generates heat to independently heat the cook block 220. The connection block 224 is coupled with the cook block 220 to couple the top punch 219 with the connection manifold 203.

The cook block 220 has the food contact surface 228 adapted to contact and compress the raw ingredients 12 and a sidewall 230 that extends around the food contact surface 228 as depicted in FIGS. 23-25. The sidewall 230 tapers into a smaller area to provide a space 232 for inadvertent ingress of raw ingredients 12, food product 14, and other debris which can then be blown out by the air knife 164. For example, raw ingredients 12 may be inadvertently squeezed between the cook block 220 and the top ring plate 160 and cooked by the sidewall 230. In conventional compression head assemblies, the cooked food may become charred and/or remain on the sidewall 230 until the assembly is shutdown and cleaned. The air knife 164 or other means in the present disclosure blows away or otherwise removes the debris from the space 232 during the continuous operation method 20 to clean the cook block 220. In illustrative embodiments, the side wall 230 of the top punches 219 has a height large enough such that when the top punches 219 are fully extended into the holes 142 in the bottom ring plate 140, the taper of the space 232 is within or above the holes 162 in the top ring plate 160. As a result, the space 232 may pump material out of the gap between the side wall 230 and the holes 162 in the top ring plate 160. The bottom punches 218 may operate in a similar way.

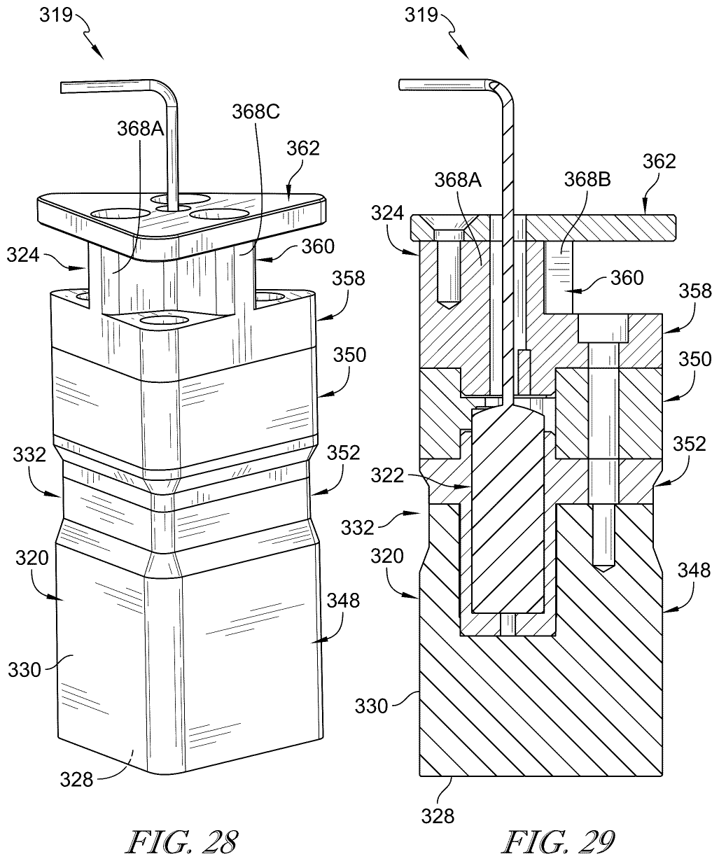

The space 232 is defined by different sections of the cook block 220 as depicted in FIGS. 23-25. The cook block 220 has a first section 236 that includes the food contact surface 228, a second section 238 located between the first section 236 and the connection block 224, and a tapered section 240 extending between and interconnecting the first section 236 and the second section 238. The first section 236 has a first cross-sectional area and the second section 238 has a second cross-sectional area that is less than the first cross-sectional area to provide the space 232 for debris to move into during operation of the top punch 219. In the illustrative embodiment, the cook blocks of the top punches 219 and the bottom punches 218 are circular. In other embodiments, such as one depicted in FIGS. 28-31, the cook blocks of the top punches 319 and the bottom punches 318 are non-circular, for example they may be triangular, elliptical, asymmetrical, etc. In other embodiments, the shape, pattern, and/or number of punches 218, 219 may differ between compression head assemblies 114.

In some embodiments, the cook block 220 further includes a third section 242 and a second tapered section 244 as depicted in FIGS. 23-25. The third section 242 is located between the second section 238 and the connection block 224. The third section 242 has a third cross-sectional area that is greater than the second cross-sectional area and the second tapered section 244 extends between and interconnects the third section 242 and the second section 238. The third cross-sectional area may be equal to the first cross-sectional area. The sidewall 230 may define the first section 236, the first tapered section 240, the second section 238, the second tapered section 244, and the third section 242. In other embodiments, the second section 238 and its cross-sectional area size extend to the connection block 224.

The cook block 220 includes a cook head 248 and a thermal insulation layer 250 as depicted in FIGS. 23-25. The thermal insulation layer 250 has a lower coefficient of thermal conductivity than the cook head 248. The illustrative cook block 220 includes an optional heater block 252. The cook head 248 comprises metallic material and is adapted to compress and cook the raw ingredients 12. The cook head 248 includes the first section 236, the first tapered section 240, and a portion of the second section 238. The cook head 248 comprises steel in the illustrative embodiment. In some embodiments, the punch assemblies 200, 201 are designed such that the punches 218, 219 and cook blocks 220, 220′ do not need to be oiled or seasoned, resulting in easier cleaning of the cook blocks 220, 220′, for example, due to material choice and/or better thermal control through individual heaters 222, 222′.

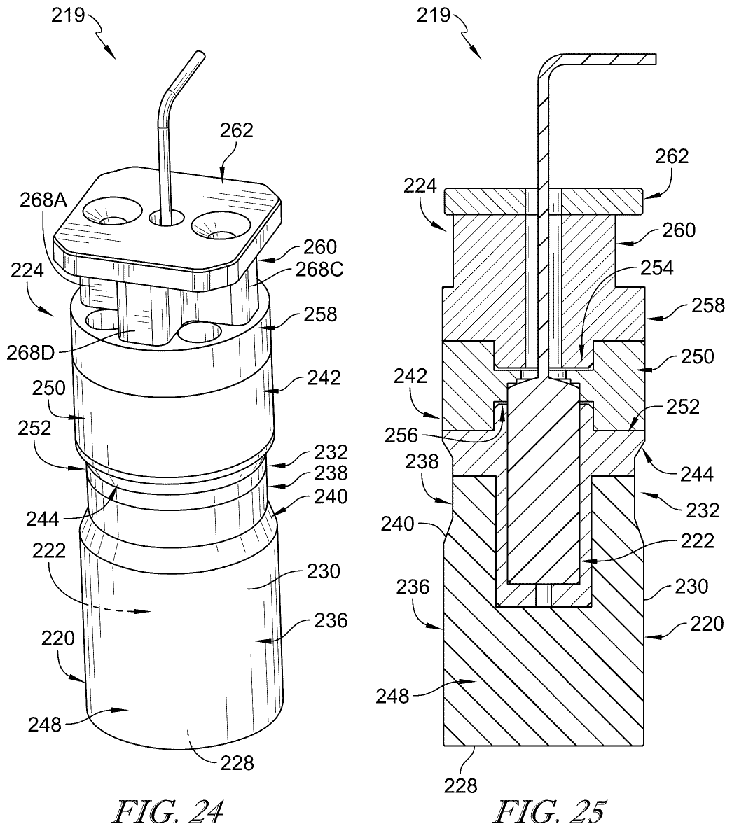

The thermal insulation layer 250 is located between the connection block 224 and the cook head 248 to reduce thermal transfer away from the cook block 220 to the connection block 224. The thermal insulation layer 250 is coupled with the heater block 252, but may be coupled with the cook head 248. The thermal insulation layer 250 has a lower coefficient of thermal conductivity than the cook head 248 and heater block 252. In some embodiments, the thermal insulation layer 250 comprises polymeric, metallic, and/or ceramic material. In the illustrative embodiment, the thermal insulation layer 250 comprises polyether ether ketone. The thermal insulation layer 250 includes a portion of the third section 242. The thermal insulation layer 250 may be shaped to include an upper bore 254 and a lower bore 256 to form an H-shaped cross-section as shown in FIG. 24. Illustratively, the lower bore 256 includes a plurality of different diameter bores. A hole is formed in the thermal insulation layer 250 to allow electrical wires to pass through to the heater 222.

The heater block 252 is coupled with the cook head 248 and transfers heat from the heater 222 to the cook head 248 as depicted in FIGS. 23-25. The heater block 252 comprises metallic material. In the illustrative embodiment, the heater block 252 comprises aluminum. The heater block 252 has a greater coefficient of thermal conductivity than the cook head 248. The heater block 252 is shaped with a cavity to receive the heater 222 therein. The heater block 252 includes a disk body and shaft that extends from the disk body into the cook head 248. A passage extends into the disk body and the shaft to form the cavity. The heater block 252 may include a portion of the third section 242 and the second tapered section 244. In some embodiments, the heater block 252 is omitted or integral with the cook head 248. The design and materials of the heater block 252 and the cook block 220, and their respective conductivities, are chosen to evenly dissipate the heat from the heater 222 to the food contact surface 228 such that the food contact surface 228 has an even temperature across the surface and evenly cooks the raw ingredients 12.

The heater 222 in each top punch 219 is located in the cook block 220 and wiring may extend through the connection block 224 as depicted in FIG. 25. In the illustrative embodiment, the heater 222 is located in the heater block 252 and a portion of the heater 222 extends into the lower bore 256 of the thermal insulation layer 250 and the thermal insulation layer 250 reduces heat transfer to the connection block 224. The hole in the thermal insulation layer 250 may be sized to allow the wires to pass through, but not the heater 222. The heater 222 may include an electrically powered heat source. The illustrative heater 222 includes an inductive coil heating element. In other embodiments, the heater 222 may include a film heater, a magnetic coil heating element, or any other suitable heat source. The heaters 222 are electrically connected with the controller 194 to be controlled by the controller 194. In some embodiments, the heaters 222 are connected with a different controller.

Each top punch 219 further includes a temperature sensor 274 located in the cook block 220 and connected with the controller 194 to measure a temperature of the cook block 220 as depicted in FIGS. 23-25. The temperature sensor 274 sends a signal to the controller 194 indicative of a temperature of the food contact surface 228. The temperature sensor 274 extends into the cook head 248 in the illustrative embodiment. Wiring from the temperature sensor 274 may extend through holes in the heater block 252, the thermal insulation layer 254, and the connection block 224. The temperature sensor 274 is therefore located at or near the cook surface 228 and is more accurate than conventional sensors that may be in a punch manifold or heat block configured to heat multiple punches. The punches of the present disclosure were found to operate the heaters 222 at a lower set temperature as compared to heaters in conventional heat blocks that heat multiple punches due to the accuracy and speed in which the temperature sensors 274 are able to detect temperature at each punch.

In some embodiments, less than all top punches 219 include a temperature sensor 274. In some embodiments, the top punches 219 do not include heaters 222 and/or temperature sensors 274. In such embodiments, the connection manifold 203 may include one or more heat elements for heating the top punches via conductive or convective heating for example. In such embodiments, the thermal insulation layer 254 may be omitted.

The connection block 224 is coupled with the cook block 220 and configured to removably couple the top punch 219 with the connection manifold 203 as depicted in FIG. 21. The connection block 224 includes a connection block base 258, a connection post 260, and a slider plate 262 as depicted in FIGS. 24 and 25. The connection post 260 couples the connection block 224 with the connection manifold 203. The connection block base 258 may have a contour and size that is similar to the third section 242 or the second section 238 if the second section 238 is the uppermost section of the cook block 220. The connection post 260 extends away from the connection block base 258 and is arranged to extend through one of the slots 205 formed in the connection manifold 203. The slider plate 262 is removably coupled with the connection post 260 to trap the connection manifold 203 between the slider plate 262 and the connection block base 258 as depicted in FIG. 23.

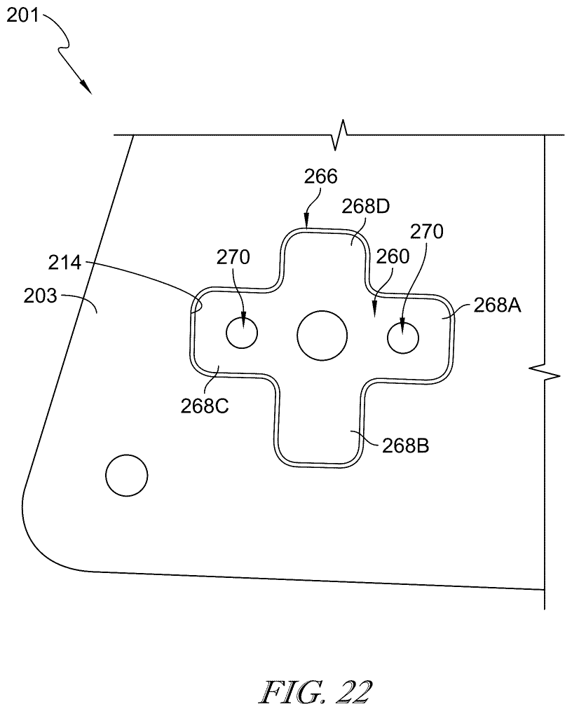

The connection post 260 has a positive contour that mates with the negative contour of the slot 205 as suggested in FIGS. 21 and 22. In other words, the connection post 260 and the slot 205 have corresponding contours. The connection post 260 and the slot 205 are sized such that a gap 266 is formed between the connection post 260 and the sidewall 214 of the connection manifold 203 as depicted in FIG. 22. The gap 266 is formed between the connection post 260 and the connection manifold 203 to allow movement of the top punch 219 in the slot 205 so that the cook block 220 may be aligned with the hole 142 in the bottom ring plate 140. The gap 266 further allows alignment of the cook block 220 with the top hole 162 in the top ring plate 160 in embodiments having the top ring plate 160. As a result, the cook block 220 is aligned with and moves into and out of the hole 142 even if heat has caused thermal expansion of the connection manifold 203, the top punch 219, and/or the bottom ring plate 140. The gap 266 may extend entirely around the connection post 260 or along only a portion of the connection post 260.

The connection post 260 is made of a plurality of segments that provide the positive contour as depicted in FIGS. 22 and 24. The segments extend at angles away from one another so that the connection post 260 is non-circular when viewed axially and the segments can engage the sidewall 214 to limit rotation of the top punch 219 relative to the connection manifold 203. In some embodiments, the connection post 260 is any non-circular shape and, in other embodiments, the connection post 260 may be circular.

The segments include a first segment 268A, a second segment 268B, a third segment 268C, and a fourth segment 268D as shown in FIG. 22. The first segment 268A extends at an angle relative to the second segment 268B to define at least a portion of the first positive contour. The segments may include one segment, two segments, three segments, etc. The first segment 268A extends at an angle of about 90 degrees relative to the second segment 268B. In other embodiments, the first segment 268A may extend at any suitable angle relative to the second segment 268B. The first segment 268A and the second segment 268B may be spaced apart from one another as discrete posts. The first segment 268A and the second segment 268B may not be parallel, as shown in FIG. 21, or may be parallel.

The third segment 268C forms about a 90 degree angle with the second segment 268B and about a 180 degree angle with the first segment 268A. The fourth segment 268D forms about a 90 degree angle with the first segment 268A and third segment 268C and about a 180 degree angle with the second segment 268B. The first segment 268A and the third segment 268C are formed with threaded holes 270 to receive fasteners 272 therein. The first segment 268A, the second segment 268B, and the third segment 268C may have similar lengths and the fourth segment 268D may have a different length to allow installation in the slot 205 in only one orientation.

The slider plate 262 removably couples with the connection post 260 and cooperates with the connection block base 258 to block vertical movement of the top punch 219 relative to the connection manifold 203 as suggested in FIGS. 21 and 23. As a result, the connection post 260, and thus the top punch 219, is free to move in the gap 266 in the X-direction and Y-direction (horizontal plane), but is restricted in the Z-direction (vertical direction). The slider plate 262 is located at least partway within the pocket 208. In other embodiments, the pockets 208 may be omitted and the slider plate 262 may engage with the outer surface 204. The slider plate 262 and the pocket 208 have a matching contour. The slider plate 262 and the pocket 208 are non-circular and, as a result, the slider plate 262 may engage the sidewall 216 to limit rotation of the top punch 219. The connection block 224 further includes fasteners 272 that extend through holes in the slider plate 262 and the holes 270 in the connection post 260 to threadingly couple with the connection post 260 as suggested in FIG. 21. In some embodiments, the connection post 260 is coupled to the slider plate 262 such that there is a gap left between the connection block 224 and a surface of the connection manifold plate 203 facing the connection block 224.

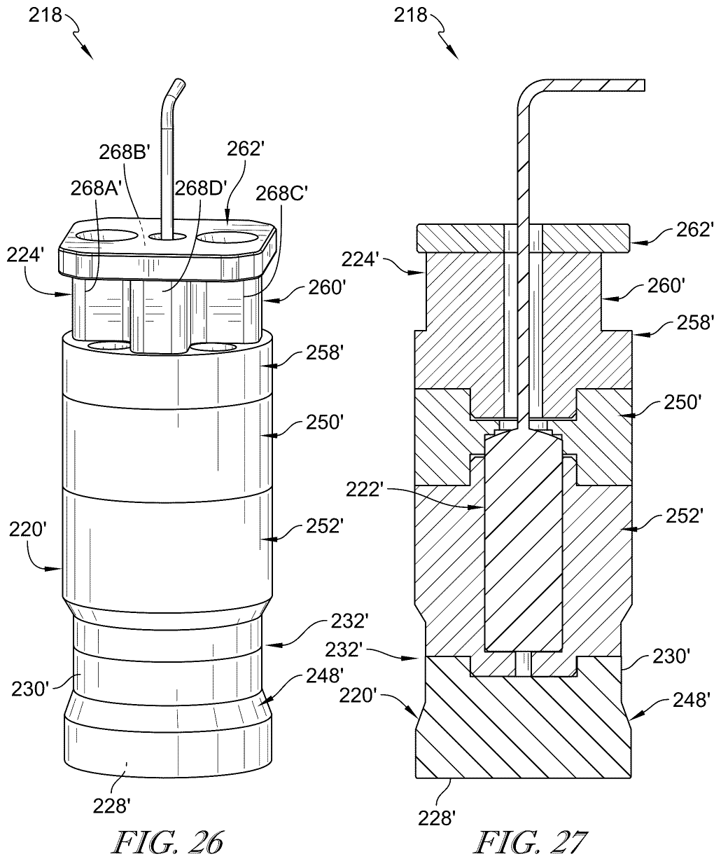

Each bottom punch 218 is substantially similar to the top punch 219 as suggested in FIGS. 26 and 27. Reference numbers in the 200′ series are used to describe elements of the bottom punches 218 and correlate with the 200 series reference numbers used to describe the elements of the top punches 219. Elements in the 200′ series are substantially the same as the corresponding elements in the 200 series unless stated otherwise below.

Each bottom punch 218 includes a cook block 220′, a heater 222′, and a connection block 224′ as depicted in FIGS. 26 and 27. The cook block 220′ has the food contact surface 228″ adapted to contact and compress the raw ingredients 12 and a sidewall 230′ that extends around the food contact surface 228′. The sidewall 230′ tapers into a smaller cross-sectional area to provide a space 232′ to capture inadvertent ingress of raw ingredients 12, food product 14, and other debris. The cook block 220′ includes a cook head 248′, a thermal insulation layer 250′, and a heater block 252′. The cook head 248′ has a smaller height than the cook head 248 of the top punch 219. The disk portion of the heater block 252′ has a greater height as compared to the disk portion of the heater block 252 of the top punch 219. The connection block 224′ is coupled with the cook block 220′ and configured to removably couple the bottom punch 218 with the connection manifold 202. The connection block 224′ includes a connection block base 258′, a connection post 260′, and a slider plate 262′. Each bottom punch 218 further includes a temperature sensor similar to the temperature sensor 274. The connection post 260′ includes a first segment 268A′, a second segment 268B′, a third segment 268C′, and a fourth segment 268D′.

Another embodiment of a top punch 319 in accordance with the present disclosure is shown in FIGS. 28 and 29. The top punch 319 is substantially similar to the top punch 219 shown in FIGS. 24 and 25 and described herein. Accordingly, similar reference numbers in the 300 series indicate features that are common between the top punch 219 and the top punch 319. The description of the top punch 219 is incorporated by reference to apply to the top punch 319, except in instances when it conflicts with the specific description and the drawings of the top punch 319.

The top punch 319 includes a triangle shaped cook block 320 and connection block 324 as depicted in FIGS. 28 and 29. The top punch 319 may be used to form triangular shaped food product 14 and extend into triangular shaped holes in ring plates. Each top punch 319 includes the cook block 320, a heater 322, and the connection block 324. The cook block 320 has the food contact surface 328 adapted to contact and compress the raw ingredients 12 and a sidewall 330 that extends around the food contact surface 328. The sidewall 330 tapers into a smaller cross-sectional area to provide a space 332 to capture inadvertent ingress of raw ingredients 12, food product 14, and other debris. The cook block 320 includes a cook head 348, a thermal insulation layer 350, and a heater block 352. The connection block 324 is coupled with the cook block 320 and configured to removably couple the top punch 319 with a connection manifold. The connection block 324 includes a connection block base 358, a connection post 360, and a slider plate 362. Each punch 319 further includes a temperature sensor similar to the temperature sensor 274. The connection post 360 includes a first segment 368A, a second segment 368B, and a third segment 368C.

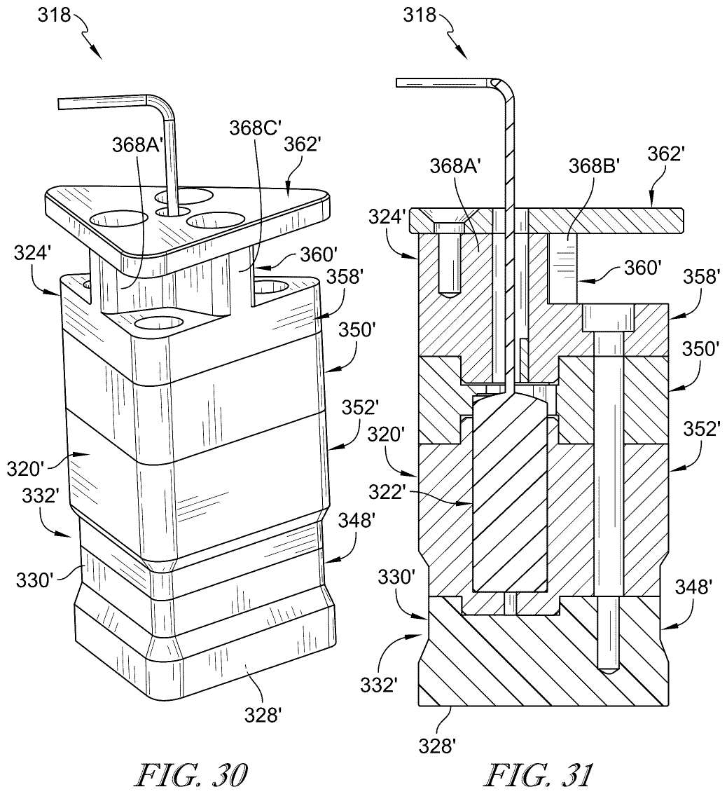

Another embodiment of a bottom punch 318 in accordance with the present disclosure is shown in FIGS. 30 and 31. The bottom punch 318 is substantially similar to the bottom punch 218 shown in FIGS. 26 and 27 and described herein. Accordingly, similar reference numbers in the 300 series indicate features that are common between the bottom punch 218 and the bottom punch 318. The description of the bottom punch 218 is incorporated by reference to apply to the bottom punch 318, except in instances when it conflicts with the specific description and the drawings of the bottom punch 318.

The bottom punch 318 includes a triangle shaped cook block 320′ and connection block 324′ as depicted in FIGS. 30 and 31. The bottom punch 318 may be used to form triangular shaped food product 14 and extend into triangular shaped holes in ring plates. Each bottom punch 318 includes the cook block 320′, a heater 322′, and the connection block 324′. The cook block 320′ has the food contact surface 328′ adapted to contact and compress the raw ingredients 12 and a sidewall 330′ that extends around the food contact surface 328′. The sidewall 330′ tapers into a smaller cross-sectional area 332′ to provide a space to capture inadvertent ingress of raw ingredients 12, food product 14, and other debris. The cook block 320′ includes a cook head 348′, a thermal insulation layer 350′, and a heater block 352′. The connection block 324′ is coupled with the cook block 320′ and configured to removably couple the bottom punch 318 with a connection manifold. The connection block 324′ includes a connection block base 358′, a connection post 360′, and a slider plate 362′. Each punch 318 further includes a temperature sensor similar to the temperature sensor 274. The connection post 360′ includes a first segment 368A′, a second segment 368B′, and a third segment 368C′.

A method of aligning the punch assembly 200 components of the compression head assembly 114 may include a number of steps. The punch assembly 200 with bottom punches 218 is described; however, it is understood that the method steps apply to the top punch assembly 201, other punches 219, 318, 319, and alternative configurations thereof. The method may include positioning a first portion of one of the punches 218 through the slot 205 formed in the connection manifold 202 such that the gap 266 is formed between the first portion of punch 218 and the connection manifold 202. The method includes locating a second portion of the punch 218 in a hole 142 formed in a ring plate 140 to cause the first portion of the punch 218 to move in the slot 205. In the illustrative embodiment, the first portion of the punch 218 includes the connection post 260′ and the second portion of the punch 218 includes the cook head 248′ of the cook block 220″.

The method includes blocking relative axial movement between the punch 218 and the connection manifold 202 in a first direction after locating the second portion of the punch 218 in the hole 142 formed in the ring plate 140 while allowing limited movement in a second direction and third direction perpendicular to the first direction to assist in alignment of the second portion of the punch 218 and the hole 142 formed in the ring plate 140. The method includes moving the punch 218 and connection manifold 202 relative to the ring plate 140 to compress and heat raw ingredients 12 with the first portion of the punch 218.

The step of blocking relative movement between the punch 218 and the connection manifold 202 may include interlocking the connection manifold 202 between a slider plate 262′ and connection block base 258′ included in the first portion of the punch 218 while allowing limited movement of the slider plate 262′ and the connection block base 258′ relative to the connection manifold 202 in the second direction and the third direction. The step of blocking relative movement between the punch 218 and the connection manifold 202 may include limiting rotational movement of the second portion of the punch 218 relative to the connection manifold 202. The method may further include heating the second portion of the punch 218 while the second portion of the punch 218 is located in the hole 142 formed in the ring plate 140.

As suggested in FIGS. 1A, 2, 3, and 32, the feed system 400 meters and delivers the raw ingredients 12 to the compression head assemblies 114 as the compression head assemblies 114 move along the carriage path 16. The feed system 400 includes at least one feed assembly 412, at least one storage container assembly 444, a moving frame 414, and a base 416 as depicted in FIGS. 1A, 2, 3, and 32. In some embodiments, the feed system 400 does not include a storage container assembly 444, and hoppers 420 of the feed system 400 are fed directly from the supply 451. Flexible connections and/or a valves may be disposed between the supply 451 and the hoppers 420 to control the flow of material to the hoppers 420.

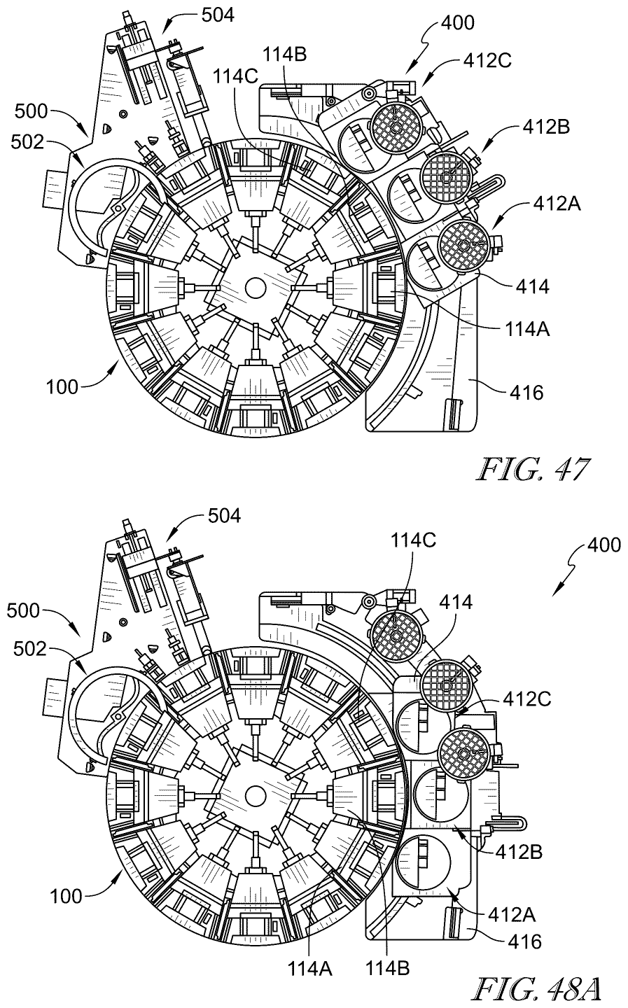

In the Illustrative embodiment, the feed system 400 includes a plurality of feed assemblies 412. As shown in FIG. 1A, the feed system 400 includes a first feed assembly 412A, a second feed assembly 412B, and a third feed assembly 412C. In other embodiments, one, two, or any number of feed assemblies 412 may be used. In some embodiments, one feed assembly 412 may feed multiple compression head assemblies 114. In some embodiments, one compression head assembly 114 may be fed by multiple feed assemblies 412, for example, containing different raw ingredients 12 or dosing different quantities. In some embodiments, one or more of the feed assemblies 412 may be turned off such that only some of the compression head assemblies 114 are fed with raw ingredients 12. The feed assemblies 412 are coupled with the moving frame 414 which is configured to move relative to the base 416 as suggested in FIGS. 47-50. The features of the feed assemblies 412 are further applicable to conventional expanded food making apparatuses that use stationary compression head assemblies and feed systems.

The feed assemblies 412 are each configured to provide doses of a predetermined volume of the raw ingredients 12 and to deliver the doses to one of the compression head assemblies 114 as that compression head assembly 114 travels along the carriage path 16. The base 416 is stationary relative to the axis 102 of the carriage system 100. The moving frame 414 is movable relative to the base 416 and travels along a feed path to align the plurality of feed assemblies 412 with corresponding compression head assemblies 114 to allow the feed assemblies 412 to deliver the doses of raw ingredients 12 to the compression head assemblies 114.

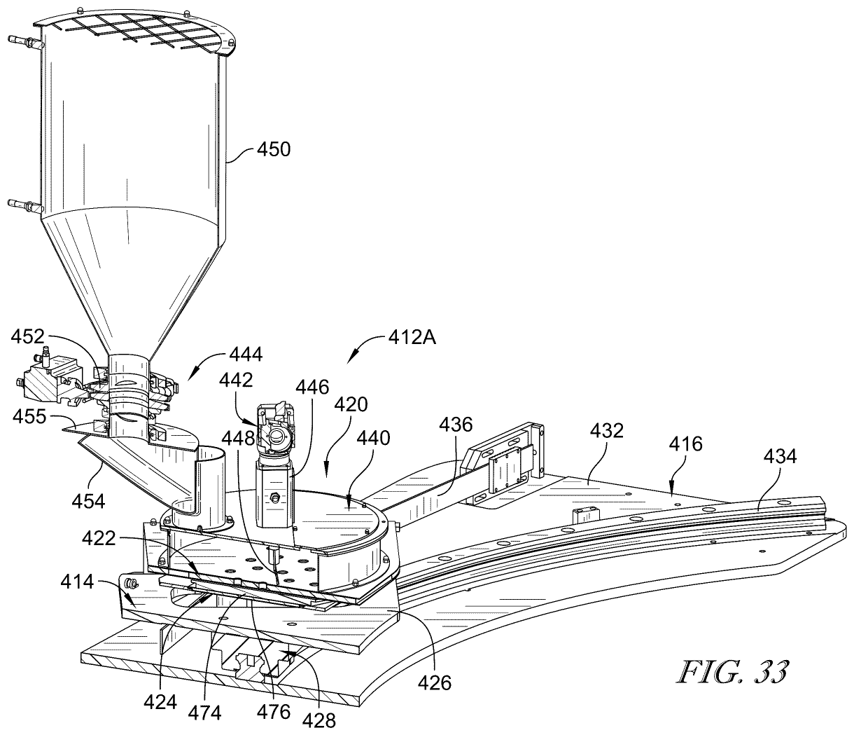

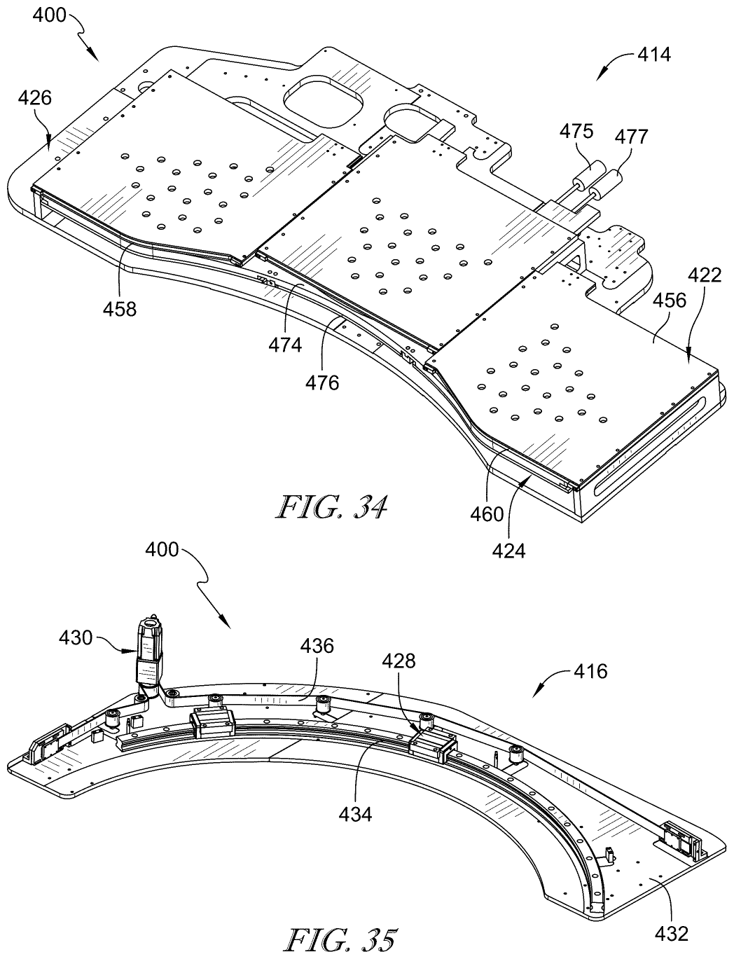

Each feed assembly 412 includes a hopper 420, a metering unit 422, and a dosing unit 424 as depicted in FIG. 33, which shows a section through feed assembly 412A as an example. The hopper 420 stores a first amount of the raw ingredients 12 in the hopper 420 for providing to the metering unit 422. The metering unit 422 apportions (or meters) the plurality of doses (or single dose in some embodiments) of the raw ingredients 12 having the predetermined volume from an amount of the raw ingredients 12 in the hopper 420. The dosing unit 424 receives the plurality of doses of the raw ingredients 12 from the metering unit 422 and delivers the plurality of doses of the raw ingredients to the compression head assembly 114. In response to the metering unit 422 supplying the apportioned doses to the dosing unit 424, the metering unit 422 apportions another round of the plurality of doses to resupply the dosing unit 424. Such metering and supplying is repeated continuously during operation of the apparatus 10.

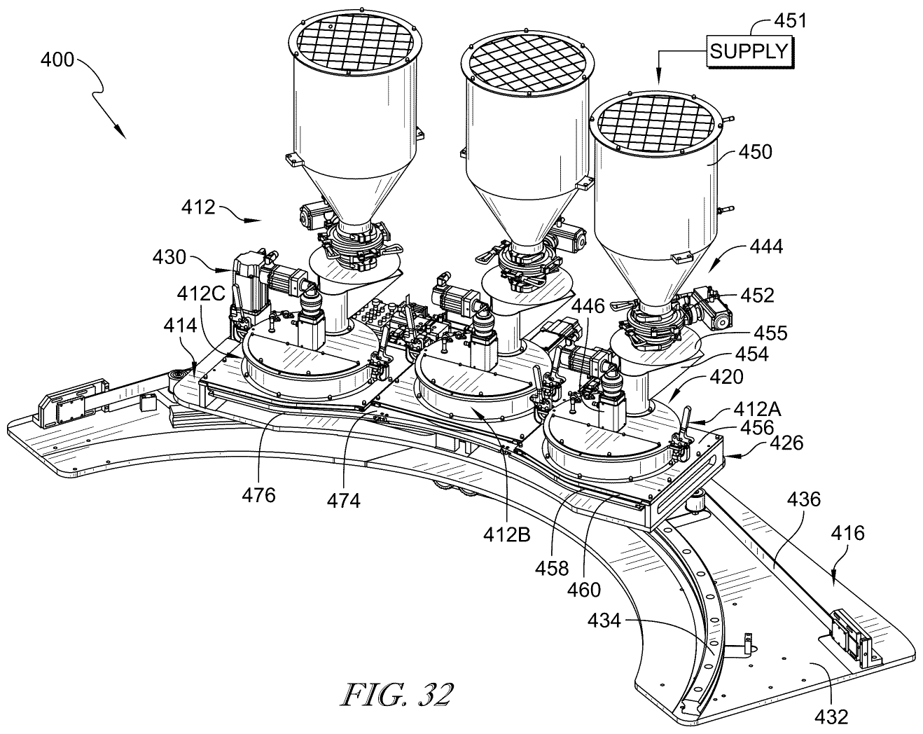

The moving frame 414 includes a frame body 426 coupled with the feed assemblies 412, guides 428 coupled with the frame body 426 and the base 416, and a drive unit 430 coupled with the frame body 426 as depicted in FIGS. 32 and 33. The frame body 426 may include a flat plate. The guides 428 are formed with a slot that receives a portion of a guide rail 434 included in the base 416 to guide the moving frame 414 along the feed path as suggested in FIGS. 33 and 35. The drive unit 430 includes a motor and spindles or other drive mechanisms such as gears, sprockets, etc. that are driven by the motor. The motor is coupled with the moving frame 414 and the spindles are located under the moving frame 414 opposite the motor in the illustrative embodiment.

The base 416 includes a base frame 432, a guide rail 434 coupled with the base frame 432, and a drive belt 436 coupled with the base frame 432 as depicted in FIGS. 32, 33, and 35. The base frame 432 may include a flat plate with a cutout sized to allow the compression head assemblies 114 to travel along the edge of the base frame 432 as the compression head assemblies 114 rotate about the axis 102. The guide rail 434 extends in an arcuate path to define the feed path. The guide rail 434 is coupled with the guides 428 to cause the moving frame 414 to travel along the feed path. In other embodiments, the guide rail 434 and feed path may be any shaped path, including linear, constant or varying curves, or unique and bespoke shapes. In the illustrative embodiment, the guide rail 434 has a constant radius and extends only partway circumferentially about the axis 102. The drive belt 436 extends generally along the guide rail 434. The drive belt 436 is formed without ridges or teeth in the illustrative embodiment. In other embodiments, the drive belt 436 may include a timing belt with ridges or teeth, chain, a track for wheels, or other suitable alternatives.

The drive unit 430 and the drive belt 436 cooperate to allow selective movement of the moving frame 414 along the feed path. Rotation of the motor of the drive unit 430 causes the spindle to rotate and drive along the drive belt 436 pulling the moving frame 414 along the feed path. The motor direction is reversible to cause the spindle to move the moving frame 414 in both a first direction and a second direction. The base 416 includes a plurality of tension spindles to help keep the drive belt 436 taut.

The hopper 420 of each feed assembly 412 includes a filling duct 454, a hopper housing 440 connected to the filing duct 454 via an inlet, and a distribution unit 442 as depicted in FIG. 33. The hopper housing 440 stores a first amount of raw ingredients 12 therein and the distribution unit 442 moves the first amount of raw ingredients 12 in the hopper housing 440 so that the raw ingredients 12 are generally uniform and also to cause predetermined volumes of the first amount of raw ingredients 12 to pass into the metering unit 422 to provide the doses. The distribution unit 442 is configured to distribute and/or urge the first amount of raw ingredients in the hopper housing 440 into the metering unit and prevent bridging of the raw material. The distribution unit 442 may move and/or distribute the first amount of raw ingredients around the hopper housing 440 such that the raw ingredients are at a first height in a first area of the hopper housing 440 and at a second height in a second area of the hopper housing 440. For example, the distribution unit 440 may move the raw ingredients in a wave, where the raw ingredients are at the first height at a peak or crest of the wave, and at the second height behind the wave. The second height may be low enough that the metering plate 460 is exposed and/or can be seen through the raw ingredients.

In the illustrative embodiment, the distribution unit includes a motor 446 and a mixing blade 448 driven to rotate by the motor 446 about a rotation axis to move the first amount of raw ingredients 12 as a wave around the hopper housing 440 to urge the raw ingredients into the metering unit 422. One or more of the ends of the mixing blade 448 may extend to and contact the walls of the hopper housing 440. The hopper housing 440 is circular when viewed downwardly from above and the mixing blade 448 rotates about the axis to uniformly urge the raw ingredients 12 into the metering unit 422. The lack of corners in the hopper housing 440 avoids build up or non-uniform dosing of raw ingredients 12. In other embodiments, the feed assembly 412 may include an alternate distribution unit and/or method of distributing the raw ingredients 12 into the metering unit 422, such as a wiper or by vibrating the hopper housing 440. In other embodiments, the feed assembly 412 may not include a mixing blade 448 or distribution unit 442.

The storage container assembly 444 may include a storage container 450 and a valve 452 as depicted in FIG. 33. The storage container 450 stores a large volume of the raw ingredients 12. In the illustrative embodiment, each feed assembly 412 includes its own storage container 450; however, multiple or all feed assemblies 412 could share a storage container 450. As discussed further below, some features of the present disclosure may be made available when using dedicated storage containers 450 for each feed assembly 412. The storage containers 450 are fixed relative to the moving frame 414 in the illustrative embodiment. The valve 452 controls a flow of the raw ingredients 12 from the storage container 450 to the hopper housing 440 via the filling duct 454. In some embodiments, the filling duct 454 and inlet into the hopper housing 440 is offset from a center axis of the hopper housing 440, which may assist in distributing the raw ingredients 12 within the hopper 420 and prevent bridging of the raw ingredients 12. The filling duct 454 is illustratively forms a funnel and is configured to align with a plate 455 fixed with the assembly of the valve 452. The filling duct 454 and the plate 455 are spaced apart by a small gap for clearance as the filling duct 454 moves relative to the plate 455, valve 452, and storage container 450. As a result, the first amount of raw ingredients 12 in the hopper housing 440 is maintained at a desired level and may be continuously or periodically resupplied from the storage container 450.

One or more supply 451 of the raw ingredients 12 may deliver, selectively, the raw ingredients to the different storage containers 450 of the feed assemblies 412 as suggested in FIG. 32. Illustratively, the supply 451 is stationary and the hoppers 420 of the feed assemblies 412 are configured to move relative to the supply 451 and storage containers 450. The supply 451 may comprise one or more of a conveyer system, an auger, ducting, a storage tank, manual filling by employees, or any other suitable alternative for supplying the raw ingredients 12 to the storage containers 450. As discussed further below, each storage container 450 may include a unique blend of raw ingredients 12 and the one or more supplies 451 may provide the unique blends to each storage container 450. Moreover, each filling duct 454 may be aligned with any of the storage containers 450 so that the blend in each hopper housing 440 may be varied and unique. The storage container 450 and the hopper 420 form a two-stage system. The relatively larger volume of the storage container 450 allows for less frequent refills from the supply 451, while the relatively shallow depth of the hopper housing 440 preventing bridging or clumping of the raw ingredients 12 that would block or prevent flow of the raw ingredients 12 thought the feed assembly 412.

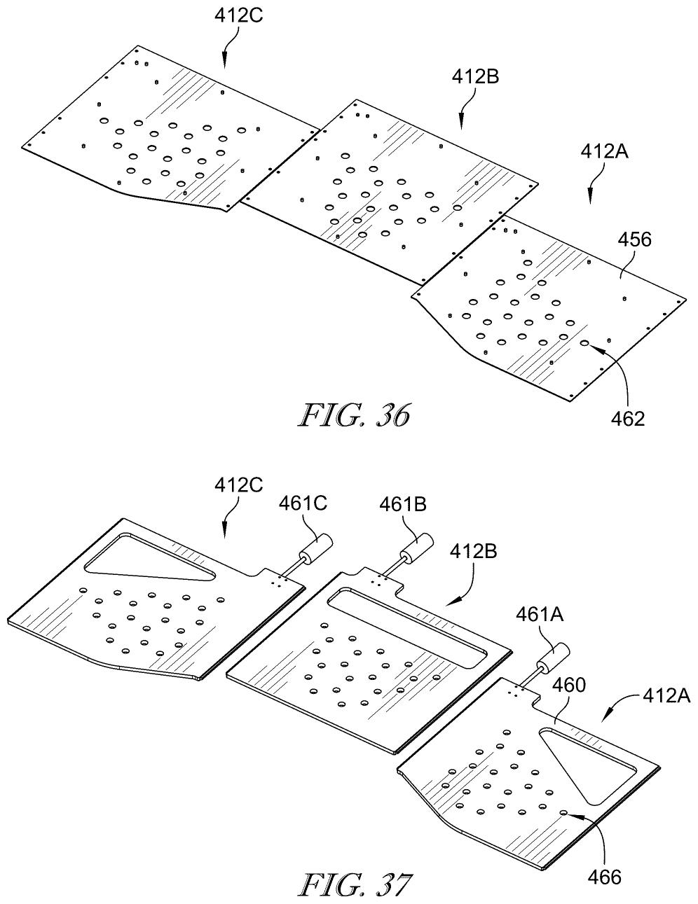

The metering unit 422 includes a first gate 456, a second gate 458, and a metering plate 460 as depicted in FIGS. 36-38, 41, and 42. The first gate 456, the second gate 458, and the metering plate 460 cooperate to collect the predetermined volumes of raw ingredients 12 from the hopper housing 440. The first gate 456 and the second gate 458 are coupled with the moving frame 414 for movement with the moving frame 414. The metering plate 460 is moveable relative to the first gate 456, second gate 458, and the moving frame 414. In other embodiments, the first gate 456 and the second gate 458 move relative to the metering plate 460.

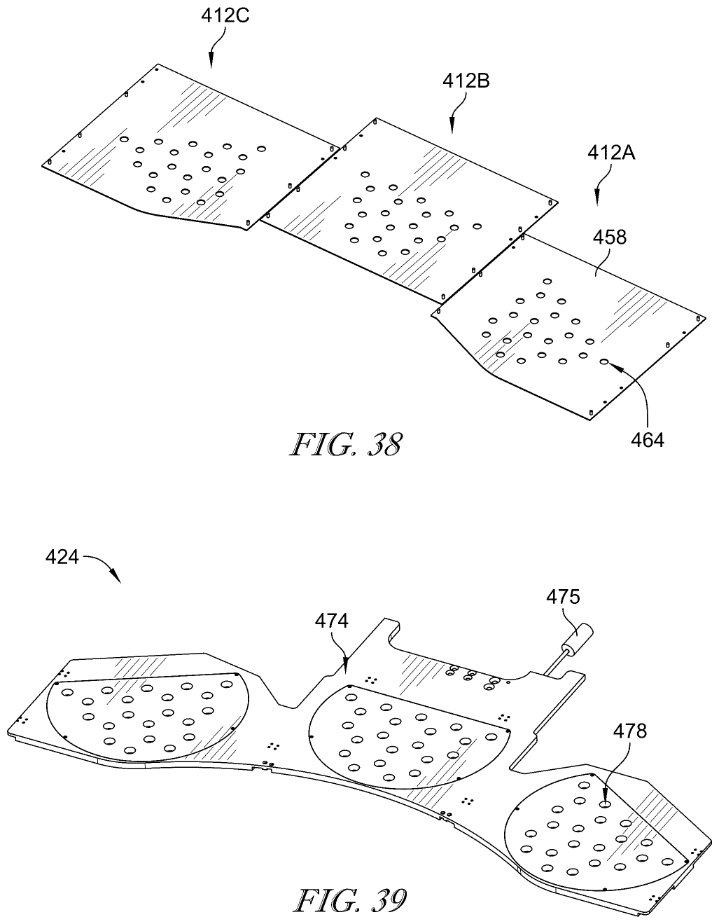

Three first gates 456, second gates 458, and metering plates 460 are shown in FIGS. 36-38 and correspond with the feed assemblies 412A, 412B, 412C. Only the components of one of the feed assemblies 412A is described in detail; however, the remaining components for the feed assemblies 412B, 412C are substantially similar to those of 412A. The first gate 456 is formed to include a single or a plurality of first gate holes 462 that extend through the first gate 456 as depicted in FIGS. 36, 41, and 42. The first gate holes 462 are in number and arranged in a pattern corresponding with the bottom punches 218, top punches 219, and bottom ring holes 142. The first gate holes 462 open directly into the hopper housing 440. The second gate 458 is formed to include a single or a plurality of second gate holes 464 that extend through the second gate 458 as depicted in FIGS. 38, 41, and 42. The second gate holes 464 are in number and arranged in a pattern corresponding with the bottom punches 218, top punches 219, and bottom ring holes 142. The second gate holes 464 are misaligned with the first gate holes 462. In the illustrative embodiment, the second gate holes are misaligned from the first gate holes 462 in a linear direction. The second gate holes 464 open directly toward the dosing unit 424. The metering plate 460 is formed to include a single or a plurality of metering holes 466 that extend through the metering plate 460 as depicted in FIGS. 37, 41, and 42. The metering holes 466 are in number and arranged in a pattern corresponding with the bottom punches 218, top punches 219, and bottom ring holes 142.

In some embodiments, the number, shape and/or pattern of the metering holes 466 and/or dosing plate holes 478 may vary between the individual feed assemblies 412A, 412B, 412C based on the food product being produced. For example, if two different food products are made in the same compression head assembly 114, the metering plate 460 and dosing plate 474 of a first feed assembly 412A may only include enough metering holes 466 and dosing plate holes 478 to correspond to a portion of the punches 218, 219 on the compression head assembly 114. The metering plate 460 and dosing plate 474 of a second feed assembly 412B may include metering holes 466 and dosing plate holes 478 corresponding to the remaining punches 218, 219 on the compression head assembly 114 not dosed from the first feed assembly 412A.

The metering holes 466 are sized such that the space defined by the metering holes, the first gate 456, and the second gate 458 is equal to the predetermined volume. As such, the metering holes 466 cooperate with the first gate 456 and the second gate 458 to cause the doses to have the predetermined volume. In the illustrative embodiment, the first gate holes 462, the second gate holes 464, and the metering holes 466 have cross-sectional shapes similar to the cross-sectional shapes of the food contact surfaces 228 of the punches. In other embodiments, one or more of the first gate holes 462, the second gate holes 464, and the metering holes 466 have cross-sectional shapes different from the cross-sectional shapes of the food contact surfaces 228 of the punches.

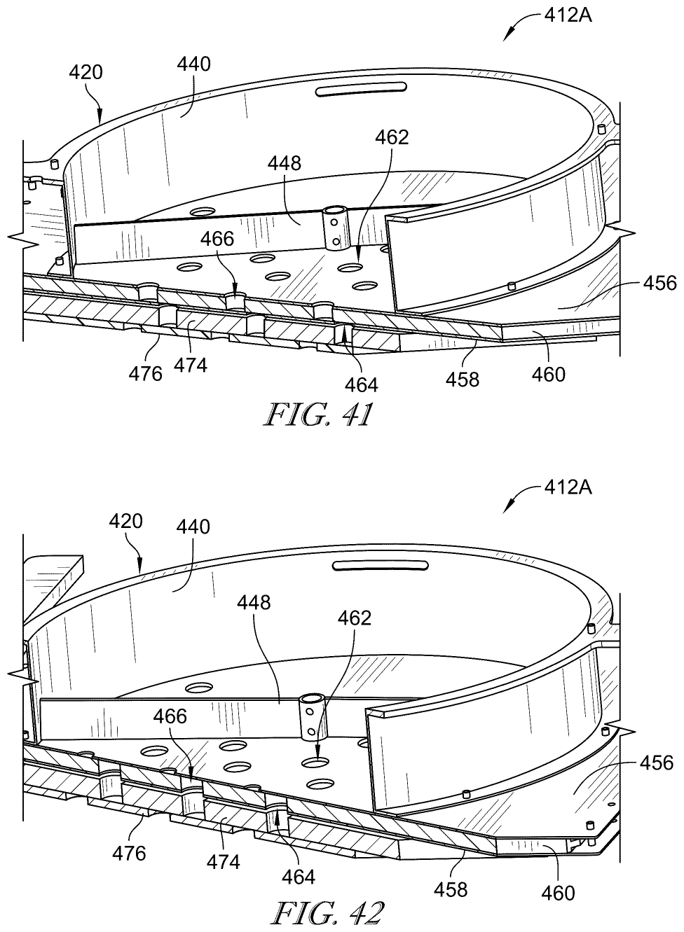

The metering plate 460 is movable between a first position to collect the doses of predetermined volume of raw ingredients 12 and a second position to deliver the doses to the dosing unit 424 as shown in FIGS. 41 and 42. In the first position, the metering holes 466 of the metering plate 460 are aligned with the plurality of first holes 462 to allow the raw ingredients 12 in the first hopper 420 to pass through the plurality of first holes 462 and into the plurality of metering holes 466 and misaligned with the plurality of second holes 464 so that the raw ingredients 12 in the plurality of metering holes 466 is blocked from escaping the plurality of metering holes 466 by the solid portions of the second gate 458 as suggested in FIG. 41. In the second position, the plurality of metering holes 466 are misaligned with the plurality of first holes 462 to block additional raw ingredients 12 from the first hopper 420 from passing into the plurality of metering holes 466 and are aligned with the plurality of second holes 464 to allow the plurality of doses of the raw ingredients 12 in the metering holes 466 to move out of the plurality of metering holes 466 and through the plurality of second holes 464 and into the first dosing unit 424 so that the dosing unit 424 stores the plurality of doses of the raw ingredients 12 having the predetermined volume as suggested in FIG. 42.

In the illustrative embodiment, each metering plate 460 of the corresponding feed assembly is movable independent of the other metering plates 460 as suggested in FIG. 37. Each metering plate 460 is coupled with its own individual actuator 461A, 461B, 461C for moving the metering plate 460 in a linear motion between the first position and the second position. In other embodiments, all metering plates 460 may be moved by a single actuator. In some embodiments, one or more of the feed assemblies 412 may be turned off such that only some of the compression head assemblies 114 are fed with raw ingredients 12. For example, one or more of the metering plates 460 may not be moved by their respective actuator 461 and may not dose the raw ingredients 12 into a respective compression head assembly 114.

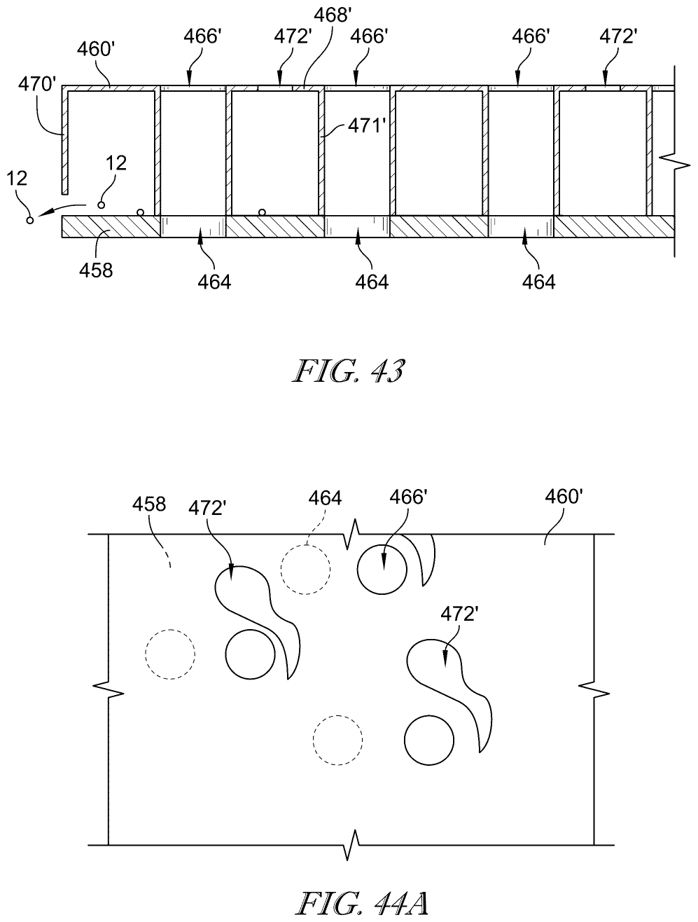

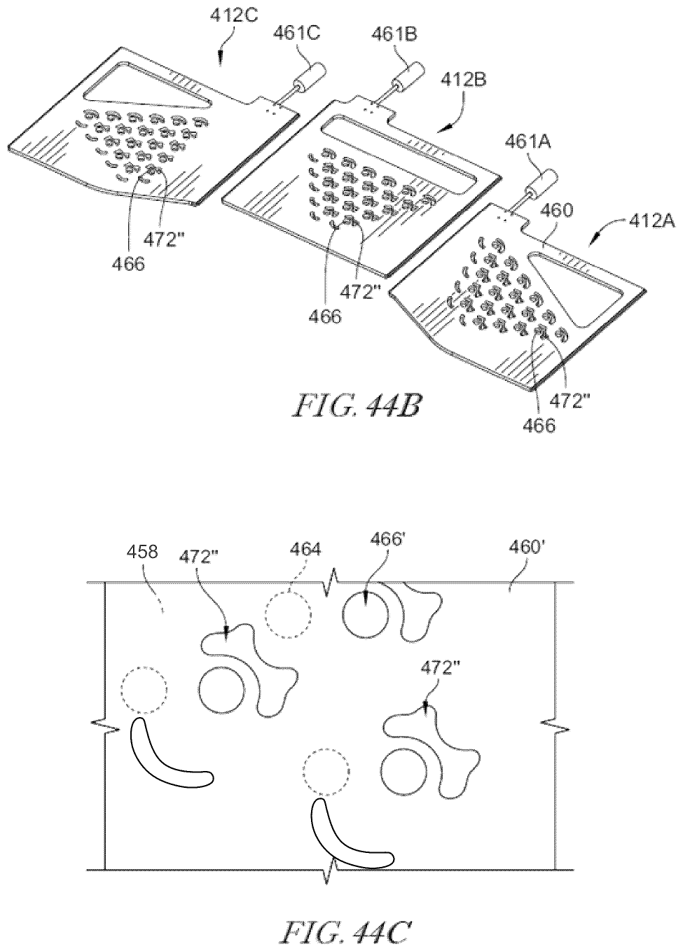

Another embodiment of a metering plate 460′ is shown in FIGS. 43 and 44A-C. Some of the raw ingredients 12 may inadvertently ingress into space between the metering plate 460 and the first gate 456. The metering plate 460 may be a solid material with metering holes 466 formed therein. In such cases, the trapped raw ingredients 12 may rub the components or urge the components apart and cause jamming or wear over time if the raw ingredients 12 are not able to escape between the components. The metering plate 460′ may alleviate the rubbing and wear. The metering plate 460′ includes a metering wall 468′ formed to define the single or the plurality of metering holes 466′ and a side wall 470′ that extends from the metering wall 468′ to form a cavity in the metering plate 460′ that opens toward the second gate 458 to allow inadvertent egress of the raw ingredients 12 to pass between the metering plate 460′ and the second gate 458. The raw ingredients 12 may then escape the metering unit 422 between the metering plate 460′ and the second gate 458 as suggested in FIG. 43.

The metering plate 460′ is further formed to include hole walls 471′ that extend from the metering wall 468′ around a perimeter of the metering holes 466′ toward the second gate 458 and terminate near the second gate 458 to block ingress of material into the second gate holes 464 of the second gate 458 as shown in FIG. 43. The hole walls 471′ size and capture the predetermined volume of raw ingredients 12 for the doses and guide the raw ingredients 12 through the second gate 458 into the dosing unit 424.

The metering plate 460, 460′ may further be formed with a single or a plurality of relief holes 472′, 472″ as depicted in FIGS. 43-44C. The relief holes 472′, 472″ extend through the metering wall 468′ and/or entirely through the metering plate 460, for example, when the metering plate 460 is a solid plate. The relief holes 472′, 472″ are spaced apart from the metering holes 466′. The relief holes 472′, 472″ allow loose raw ingredients 12 located between the metering plate 460, 460′ and the first gate 456 to pass through the metering plate 460, 460′ and escape metering unit 422 through a space between the metering plate 460, 460′ and the second gate 458 as suggested in FIG. 43. The relief holes 472′, 472″ are sized and arranged in the metering plate 460, 460′ so that the relief holes 472′, 472″ are misaligned with the first holes 462 in response to the metering plate 460, 460′ being in the first position or the second position so that the raw ingredients 12 in the hopper housing 440 does not pass directly into the relief holes 472′, 472″. In some embodiments, the relief holes 472′, 472″ are further misaligned with the second holes 464 in in response to the metering plate 460, 460′ being in the first position or the second position. For example, as shown in FIG. 44A, the metering holes 466′ are aligned with the first holes 462 and misaligned with the second holes 464 and the relief holes 472′, 472″ are misaligned with both the first holes 462 and the second holes 464. The metering plate 460′ of FIG. 44A is shown in the position illustrated in FIG. 41.

The relief holes 472′, 472″ may be of any suitable shape, including, but not limited to, slots, circles, squares, triangles, bespoke shapes, etc. As shown in FIG. 44A, the relief holes 472′ are tear shaped. In other embodiments, as shown in FIGS. 44B-44C, the relief holes 472″ are alternatively shaped. As show in FIGS. 44B-44C, the relief holes 472″ may be more freeform and/or organic in shape. In the illustrative embodiment, the relief holes 472″ are shaped similar to the outline of a dog bone. Some of the relief holes 472″ may be substantially crescent or half-moon in shape, such as those near to edge of the metering plate 460 in FIGS. 44B-44C. In some embodiments, the shape, size, and/or pattern of the metering holes 466 and/or the relief holes 472′, 472″ in the metering plates 460 may vary between the individual feed assemblies 412A, 412B, 412C based on the angle the raw ingredients 12 are feed to the feed assemblies 412A, 412B, 412C from the respective container 450.

The dosing unit 424 includes a dosing plate 474, a dosing plate actuator 475, a dosing gate 476, and a dosing gate actuator 477 as depicted in FIGS. 39, 40, 45, and 46. The dosing unit 424 temporarily stores the doses of predetermined volume of raw ingredients 12 from the metering unit 422, extends or otherwise moves into alignment with corresponding one or more compression head assemblies 114 during the feeding step 30, and delivers the doses into corresponding bottom ring holes 142 as suggested in FIGS. 45 and 46.

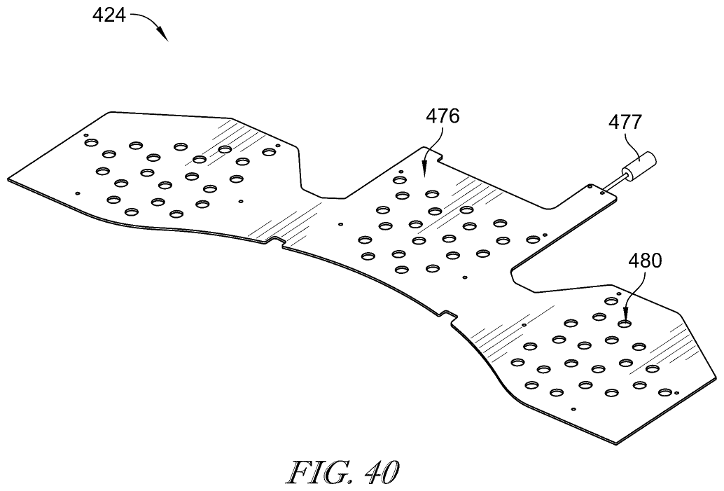

The dosing plate 474 is formed to include a single or plurality of dosing plate holes 478 that extend through the dosing plate 474 as depicted in FIGS. 39, 45, and 46. The dosing plate holes 478 are in number and arranged in a pattern corresponding with the bottom punches 218, top punches 219, and bottom ring holes 142. The dosing gate 476 is formed to include a single or a plurality of dosing gate holes 480 that extend through the dosing gate 476 as depicted in FIGS. 40, 45, and 46. The dosing gate holes 480 are in number and arranged in a pattern corresponding with the bottom punches 218, top punches 219, and bottom ring holes 142. In the illustrative embodiment, the dosing plate holes 478 and the dosing gate holes 480 have shapes similar to the shapes of the food contact surfaces 228 of the punches. In other embodiments, one or more of the dosing plate holes 478 and the dosing gate holes 480 have shapes different from the shapes of the food contact surfaces 228 of the punches. For example, in some embodiments, the dosing gate holes 480 may be circular and the food contact surfaces 228 may be triangular. In some embodiments where the dosing gate holes 480 are circular, the circular shape may help distribute the raw ingredients 12 evenly across the food contact surfaces 228 regardless of the shape of the contact surface 228. In some embodiments, the dosing gate holes 480 differ in pattern from the metering holes 466 as the metering plate 460 aligns the metering holes 466 with the first gate holes 462, the second gate holes 464, and the dosing plate holes 478 at different times during the operation cycle. In contrast, the dosing gate 476 aligns the dosing gate holes 480 with only the dosing plate holes 478.

The dosing plate 474 and the dosing gate 476 are configured to move together relative to the moving frame 414, the first gate 456, and the second gate 458 and the dosing gate 476 is further configured to move relative to the dosing plate 474 as suggested in FIGS. 45 and 46. The dosing plate actuator 475 moves the dosing plate 474 between a first position and a second position. The dosing gate actuator 477 moves the dosing gate 476 between a first position, a second position, and a third position. The actuators 475, 478 may be configured to move the dosing plate 474 and the dosing gate 476 between a plurality of positions (including infinitely variable) and to hold the dosing plate 474 and the dosing gate 476 in any of the plurality of positions. In some embodiments, the shape, size, and/or pattern of the dosing gate holes 480 in the dosing gate 476 may vary between the individual feed assemblies 412A, 412B, 412C based on the angle the raw ingredients 12 are fed into the hopper 420 from the respective storage container 450.

In the illustrative embodiment, the dosing plate 474 is formed to include all dosing plate holes 478 for all feed assemblies 412A, 412B, 412C. Movement of the dosing plate 474 is driven by the single actuator 475. In some embodiments, the dosing plate 474 is separated into multiple plates, each corresponding with one of the feed assemblies 412A, 412B, 412C and each having its own independent actuator, similar to the metering plates 460. In the illustrative embodiment, the dosing gate 476 is formed to include all dosing gate holes 480 for all feed assemblies 412A, 412B, 412C. Movement of the dosing gate 476 is driven by the single actuator 477. In some embodiments, the dosing gate 476 is separated into multiple plates, each corresponding with one of the feed assemblies 412A, 412B, 412C and each having its own independent actuator, similar to the metering plates 460.

During operation, the dosing plate 474 is moved to its first position and the dosing gate 476 to its first position as depicted in FIG. 41. The dosing plate holes 478 are aligned with the second gate holes 464 and the dosing gate holes 480 are misaligned with the dosing plate holes 478. The metering plate 460 starts in its first position, depicted in FIG. 41, with the doses of raw ingredients 12 in the metering holes 466. The metering plate 460 moves to its second position so that the doses of predetermined volume of raw ingredients 12 move through the second gate holes 464 and into the dosing plate holes 478 as suggested in FIG. 42. The dosing plate 474 remains in its first position and the dosing gate 476 remains in its first position. Because the dosing gate holes 480 are misaligned with the dosing plate holes 478, the doses of raw ingredients 12 remain in the dosing plate holes 478.

After the dosing plate 474 is supplied with the doses, the dosing plate actuator 475 cause the dosing plate 474 and dosing gate 476 to move outwardly away from the moving frame 414. The dosing plate 474 is moved to its second position and the dosing gate 476 is moved to its second position so that the dosing plate 474 and the dosing gate 476 extend into the gap 172 between the bottom platen assembly 120 and the top platen assembly 122 as depicted in FIG. 45. The dosing gate 476 is moved a same distance as the dosing plate 474 such that the dosing gate holes 480 remain misaligned with the dosing plate holes 478 and block the doses of raw ingredients 12 from escaping out of the dosing plate holes 478.

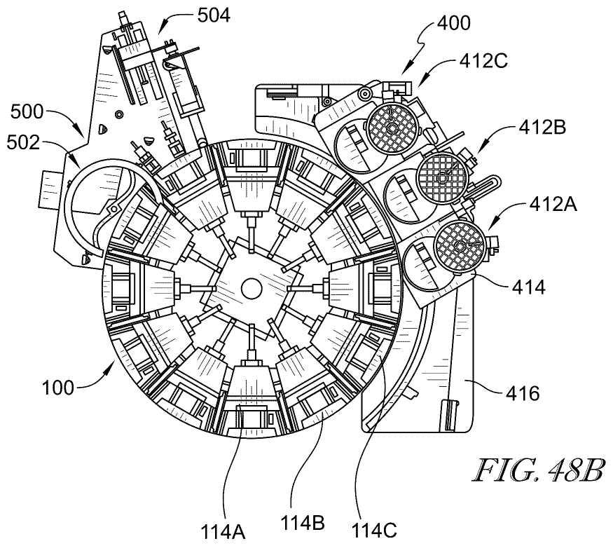

In the illustrative embodiment, the moving frame 414 moves the one or more feed assemblies 412A, 412B, 412C relative to the rotating compression head assemblies 114 so that each feed assembly 412 aligns with a corresponding compression head assembly 114 at the same time as or just prior to the dosing plate 474 and dosing gate 476 extending to their second positions as depicted in FIGS. 47-48. As a result, the dosing plate holes 478 align with the bottom ring holes 142 temporarily while the dosing plate 474 is in the second position as depicted in FIG. 45. In other embodiments with stationary compression head assemblies, such as with individual, stand-alone compression head assemblies, the moving frame 414 may be omitted and the dosing plate 474 and dosing gate 476 move to their second positions without being moved about an axis.

The dosing gate actuator 477 then moves the dosing gate 476 relative to the dosing plate 474 to the third position of the dosing gate 476 while the dosing plate 474 remains in its second position to cause the dosing gate holes 480 to align with the dosing plate holes 478 as depicted in FIG. 46. As a result, the dosing plate holes 478, the dosing gate holes 480, and the bottom ring holes 142 are all aligned and the doses of predetermined volume of raw ingredients 12 drop into the bottom ring holes 142. In the illustrative embodiment, the moving frame 414 continues to move relative to the axis 102 to maintain alignment of the dosing unit 424 with the corresponding compression head assembly 114. As depicted in FIG. 48A, feed assembly 412A is aligned with compression head assembly 114A, feed assembly 412B is aligned with compression head assembly 114B, and feed assembly 412C is aligned with compression head assembly 114C. The dosing plate holes 478 are arranged in the dosing plate 474 such that the linear motion of the dosing plate actuator 475 causes the dosing plate holes 478 to align for each compression head assembly 114A, 114B, 114C.

After the doses of raw ingredients 12 are delivered to the bottom ring holes 142, the dosing plate 474 and the dosing gate 476 are returned to their first position and the process is repeated as suggested in FIG. 41. With the doses of raw ingredients 12 delivered to the compression head assembly 114, the top punch assembly 201 and the bottom punch assembly 200 compress and heat the raw ingredients 12 as depicted in FIG. 14. In the illustrative embodiment, the moving frame 414 moves the one or more feed assemblies 412A, 412B, 412C relative to the rotating compression head assemblies 114 to a return position as depicted in FIG. 48B and the compression head assemblies 114 continue to rotate about the axis 102 as the raw ingredients 12 are being cooked. As such, the feed assemblies 412A, 412B, 412C are ready to be moved by moving frame 414 to align temporarily with and deliver doses of the raw ingredients 12 to compression head assemblies 114J, 114K, 114L as they rotate about the axis 102. The moving frame 414 is movable between a first position at an end of the feed path, a second position at an opposite end of the feed path, and any position along the feed path between the two ends of the feed path. The moving frame 414 is operable to be moved back and forth between multiple positions along the feed path. The moving frame 414 moves the feed assemblies 412A, 412B, 412C from the first position toward the second position to align the feed assemblies 412A, 412B, 412C with the compression head assemblies 114. After dosing, the moving frame 414 stops and moves back to the first position where it can move toward the second position again to align temporarily with another one or more compression head assemblies 114.

The dosing plate 474 may include features similar to those described with metering plate 460′ to allow ingresses raw ingredients 12 to escape from the dosing unit 424. The dosing plate 474 may include a wall and side walls to form a hollow cavity similar to metering wall 468′ and side wall 470′. The dosing plate 474 may further include hole walls arranged around the dosing plate holes 478 similar to hole walls 471′. Additionally or alternatively, the dosing plate 474 may be formed to include relief holes similar to relief holes 472″.

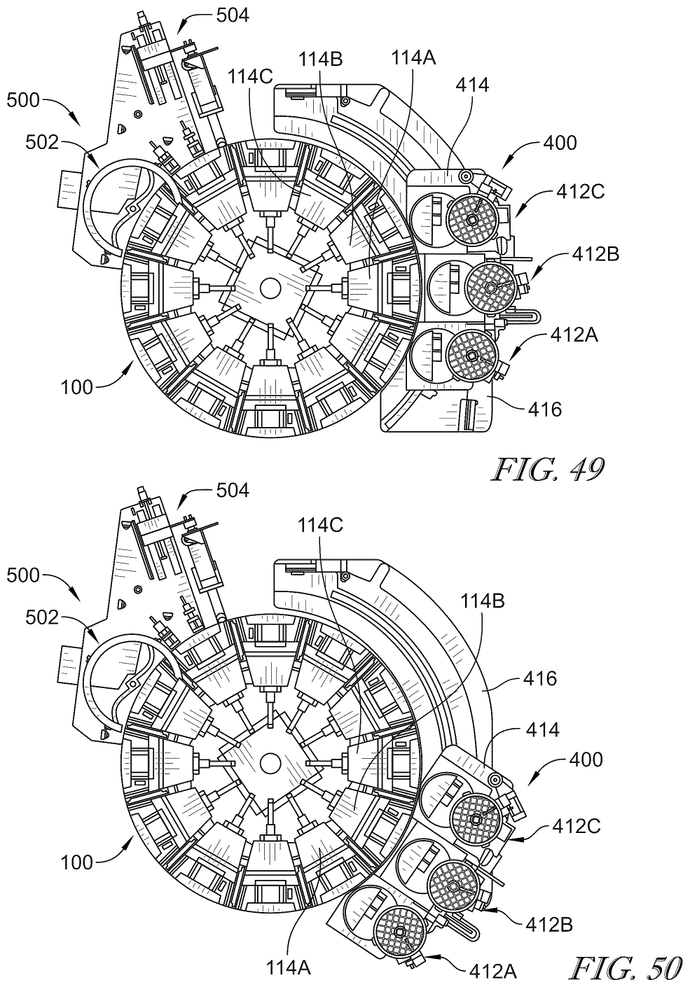

Having multiple feed assemblies 412A, 412B, 412C with independent storage containers 450 on a moving frame 414 allows for variability in the raw ingredients 12 delivered to each compression head assembly 114 as suggested in FIGS. 49 and 50. As an example, the storage container 450 for the feed assembly 412A may have a first formula of raw ingredients 12 that is different from the a second formula of raw ingredients 12 in the storage container 450 for feed assembly 412B (the formulas may include only a single ingredient or a mix of two or more ingredients). The formula of raw ingredients 12 in the storage container 450 for feed assembly 412C may be different from those in 412A and 412B. The moving frame 414 is configured to move the feed assembly 412B into alignment with rotating compression head assembly 114A and deliver a dose of its formula of raw ingredients 12 to the compression head assembly 114A as depicted in FIG. 49. The moving frame 414 then moves the feed assembly 412A into alignment with the same rotating compression head assembly 114A and to deliver a dose of its formula of raw ingredients 12 to the compression head assembly 114A as depicted in FIG. 50. As such, the compression head assembly 114A has a combination of the formulas of the raw ingredients 12 of feed assembly 412A and feed assembly 412B.

In this way, each compression head assembly 114 may be supplied, selectively, with any combination of formulas of raw ingredients 12 from feed assemblies 412A, 412B, and/or 412C. Different food products 14 may be cooked and prepared on a single apparatus 10 by altering which compression head assemblies 114 receive doses from which storage containers 450 and feed assemblies 412A, 412B, and/or 412C. Each dosing plate 474 and dosing gate 476 may have its own dedicated actuator in such embodiments.

According to embodiments of the present disclosure, the raw ingredients 12 may be or include one or more of the following: wheat, rye, maize (corn), rice, sago, sorghum, triticale, millet, beans, potatoes, or starches from these or similar sources. According to other embodiments, the raw ingredients may alternatively or additionally include protein-rich food materials or protein therefrom. Other alternative ingredients may include one or more of the following: whole pieces of beans and peas, such as green and yellow peas, black bean, garbanzo bean, chick peas; whole seeds, such as sesame, quinoa, and chia; extruded pellets, such as soy-based protein pellets, pellets containing dried fruits, and vegetable pellets made from spinach, carrots, or beet etc.

The raw ingredients 12 may be deposited (e.g., injected, dropped, slid) into the temporarily formed feed cup (bottom ring holes 142) by the dosing unit 424 or with a similar mechanism. The raw ingredients 12 may have been pre-processed, such as chopped or ground to powder or granular forms and/or mixed with condiments, before being supplied to the feed cup. According to one embodiment of the present invention, pre-processing or preparation of the raw ingredients may include pre-heating them to a desired temperature, such as a temperature between a subsequent baking temperature and room temperature. In some embodiments, the desired temperature may be below the ingredient's glass transition temperature and/or below the boiling temperature of water to retain water within the ingredients. Other examples of pre-processing may include steaming of the raw ingredients which may modify the functional properties of the raw ingredients and/or add moisture thereto. Apart from addition of moisture, the raw ingredients may be pre-processed to remove moisture.

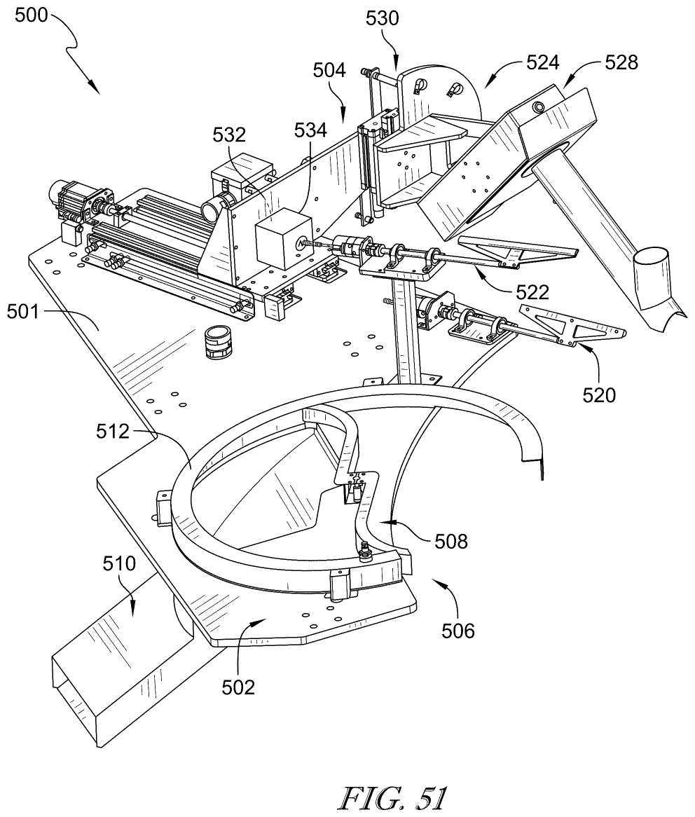

The ejection and cleaning system 500 includes a frame 501, the ejection assembly 502, and the cleaning assembly 504 as depicted in FIGS. 4 and 51. The frame 501 is stationary relative to the rotating carriage system 100 in the illustrative embodiment and supports the ejection assembly 502 and the cleaning assembly 504 above ground. The ejection assembly 502 is located downstream of the feed system 400 and performs the ejection step 50 to remove the food products 14 from each compression head assembly 114 as they rotate past the ejection assembly 502 along the carriage path. In other embodiments, the ejection assembly is coupled with the carriage system 100 for movement therewith. For example, such an ejection assembly may include conventional mechanisms for urging the food products 14 away from the compression head assemblies 114. The cleaning assembly 504 is located downstream of the ejection assembly 502 and performs the cleaning step 60 to removes remnants of raw ingredients 12, food product 14, or other food debris on the compression head assemblies 114. In other embodiments, at least part of the ejection and cleaning system 500 may be integrated with the feed system 400. In other embodiments, at least part of the ejection and cleaning system 500 may be integrated with the compression head assembly 114.

The ejection assembly 502 includes an ejector 506 that is coupled with the frame 501 as shown in FIGS. 2, 3, and 51. The ejector 506 includes the ejector arm 508 that rotates continuously or intermittently and engages the food products 14 to move the food products 14 away from each compression head assembly 114 as they move along the carriage path past the ejector 506. In particular, after the cooking step 40, the bottom punches 218 are raised by the bottom actuator 134 such that their cook surfaces 228′ are aligned with an upper surfaces of the bottom ring plate 140 as depicted in FIG. 15 (the top platen assembly 122 may be in the lowered position of FIG. 15 or the raised position of FIG. 20). The ejector arm 508 is aligned vertically so as to contact the food products 14 resting on the cook surfaces 228′ and urge the food products 14 away from the compression head assembly 114 with little or no contact to the compression head assembly 114. The ejection step 50 may include removing the food product 14 from the compression head assembly 114 by engaging the food product 14 with the ejector arm 508 to urge the food product 14 away from the compression head assembly 114. In other embodiments, the ejector arm 508 is a reciprocating device. In other embodiments, the ejector arm 508 is fixed and scrapes the food products off as the cook surfaces 228′ passes underneath the fixed ejector arm 508.

Illustratively, the ejection assembly 502 includes a chute 510 coupled with the frame 501 and the ejector arm 508 pushes the food products 14 into the chute 510 for collection, weighing, inspection, packaging, etc. In some embodiments, the chute 510 outputs the food products 14 onto a conveyor, into a trough, or any other suitable scrap removal system In other embodiments, the ejector arm 508 pushes food products 14 onto a conveyor, into a trough, or any other suitable scrap removal system. The ejector arm 508 includes a first curved member and a second curved member that extends away from the first curved member such that at least one of the curved members contact the food products 14 of any given compression head assembly 114. A motor 514 or other mover is coupled with the ejector arm 508 to cause the ejector arm 508 to rotate. A guard rail 512 extends partway around the ejector arm 508 and the chute 510 as depicted in FIG. 51. The guard rail 512 is fixed to frame 501 and does not rotate with ejector arm 508. The guard rail 512 contains food products 14 collected by the ejector arm 508 from the compression head assembly 114 so the ejector arm 508 then sweeps the contained products 14 into the chute 510.

Portions of the raw ingredients 12 as well as cooked and uncooked food product 14 may collect on components of the compression head assemblies 114. Any raw ingredients 12 and food product 14 located on the hot parts of the punches 218, 219 may overheat or burn and cause undesirable aromas, cause inefficient or inconsistent cooking between batches or within any given batch, or cause the burned food to imbed as foreign material into the raw ingredients 12 and food product 14. The cleaning assembly 504 removes the remnants of the raw ingredients 12 as well as cooked and uncooked food product 14 during operation of the apparatus 10 so that the process 20 is not stopped for cleaning of the apparatus 10. Though some cleaning and maintenance may still be performed with apparatus shut down, the cleaning assembly 504 may significantly extend the time between such shut downs.

The cleaning assembly 504 may be optional and include any one or more of a first wiper 520, a second wiper 522, and a laser head unit 524 as depicted in FIGS. 51-53. In some embodiments, for example, if the apparatus 10 is used to product non-food products or other products where contamination is not a concern, the cleaning assembly 504 may be omitted from the apparatus 10. In some embodiments, the cleaning assembly 504 may include a wiper 520, 522 and not include the laser, or vice versa. In some embodiments, the cleaning assembly 504 may include additional or alternative cleaning methods such as an air knife, an air actuator, a brush, a vacuum, an ultrasonic apparatus, or any other suitable cleaning mechanisms.

The cleaning assembly 504 is located directly upstream of the feed system 400 in the illustrative embodiment. The wipers 520, 522 are coupled with the frame 501 and are stationary relative to the rotating compression head assemblies 114. The wipers 520, 522 engage surfaces of the compression head assemblies 114 as the compression head assemblies 114 rotate past the wipers 520, 522 along the carriage path. The laser head unit 524 directs a laser beam (directed energy) at the compression head assemblies 114 to burn off the remnants of raw ingredients 12, food product 14, or other food debris. In embodiments with the locking assembly 126, the top platen assembly 122 is moved to the raised position for the cleaning step 60 to allow for maximum space for the wipers 520, 522 and the laser head unit 524. In embodiments without a moving top platen assembly 122, the wipers 520, 522 and the laser head unit 524 may operate in a smaller gap 172.

The cleaning step 60 may include removing portions of the raw ingredients 12 and the food product 14 remaining on a first surface of the compression head assembly 114, after the cooking step 40, with the first wiper 520, 522 as the compression head assembly 114 moves along the carriage path. The cleaning step 60 may include removing portions of the raw ingredients 12 and the food product 14 remaining on a second surface opposite the first surface of the compression head assembly 114, after the cooking step 40, with a second wiper 522, 520 as the compression head assembly 114 moves along the carriage path. The step 60 may include directing a laser beam onto the first surface and/or the second surface of the compression head assembly 114 to remove portions of the raw ingredients 12 and the food product 14.

The first wiper 520 engages a first exposed surface of the compression head assemblies 114 as the compression head assemblies 114 move along the carriage path 16 relative to the first wiper 520 to wipe excess raw ingredients 12 and food product 14 away from the compression head assemblies 114. The second wiper 522 engages a second exposed surface of the compression head assemblies 114 as the compression head assemblies 114 move along the carriage path 16 relative to the second wiper 522. The second exposed surface is spaced apart from and opposite the first exposed surface in the illustrative embodiment. The cleaning assembly 504 may include additional wipers for removing material from any suitable surface of the compression head assemblies 114. The first wiper 520 is shown as being used with the bottom platen assembly 120 and the second wiper 522 is shown being used with the top platen assembly 122; however, any wiper may be used with any suitable assembly or surface of the compression head assemblies 114.

During the cleaning step 60, the bottom punches 218 are raised by the bottom actuator 134 such that their cook surfaces 228′ are aligned with an upper surfaces of the bottom ring plate 140 as depicted in FIGS. 15 and 52. The first wiper 520 extends away from the frame 501 and into the gap 172 and wipes the cook surfaces 228′ and the upper surface of the bottom ring plate 140 to remove raw ingredients 12 and food product 14. The top punches 219 are lowered by the top actuator 154 such that their cook surfaces 228 are aligned with a lower surfaces of the top ring plate 160 as depicted in FIGS. 15 and 52. The second wiper 522 extends away from the frame 501 and into the gap 172 and wipes the cook surfaces 228 and the lower surface of the top ring plate 160 to remove raw ingredients 12 and food product 14. The first wiper 520 is located downstream of the second wiper 522 in the illustrative embodiment, but this positioning may be reversed.

The laser head unit 524 directs a laser beam onto the first exposed surface and/or the second exposed surface as the compression head assemblies 114 move relative to the cleaning assembly 504 about the carriage path 16 as suggested in FIGS. 51 and 53. In the illustrative embodiment, the laser head unit 524 includes a laser 528 for generating and directing the laser beam, a movable base 530 coupled with the frame 501 and configured to translate and rotate the laser 528, and a controller 532. As a result, the laser beam can be directed to any number of suitable surfaces and in any desirable pattern. As shown in FIG. 51, the controller is disposed on the cleaning system 500. In other embodiments, the controller 532 is remotely located and not disposed on the cleaning system 500 or apparatus 10. For example, the controller 532 may be located inside an electrical cabinet placed near the apparatus 10. The controller 532 may be included in the controller 194.

The cleaning system 500 may further include a sensor 534 directed at the first exposed surface or other surfaces of the compression head assemblies 114 and configured to detect the presence of food product 14 on the compression head assembly 114. In the illustrative embodiment, the sensor 534 is a visual camera 534 and the controller 532 is configured to receive input from the visual camera 534 and control movement of the laser head unit 524 based on the input from the camera 534. The camera 534 may include a visual, infra-red, or any other suitable type camera. As shown in FIG. 51, the camera 534 is mounted on the cleaning system 500. In other embodiments, the camera 534 may be disposed anywhere on or near the apparatus 10 to provide the camera 534 with a suitable view of the cleaning system 500.

As one example, the controller 532 of the laser head unit 524 is programmed to at least one of move along a linear path relative to ground and to rotate about at least one lasing axis to cause the laser beam to be directed about a surface area of the first exposed surface. As another example, the controller 532 is programmed to move the laser 528 and laser beam along a first predetermined path on the bottom platen assembly 120. As another example, the controller 532 is programmed to move the laser 528 and laser beam along a second predetermined path on the top platen assembly 122. The controller 532 may be programmed to move the laser 528 and laser beam along a third predetermined path on the bottom platen assembly 120 different from the first predetermined path and/or along a fourth predetermined path on the top platen assembly 122 different from the second predetermined path.

In some embodiments, the controller 532 is programmed to move the laser 528 and laser beam along only one of the predetermined paths for a given pass of a compression head assembly 114. In some embodiments, the controller 532 is programmed to move the laser 528 and laser beam along one of the predetermined paths for each of the bottom platen assembly 120 and the top platen assembly 122 for a given pass of a compression head assembly 114. In some embodiments, the controller 532 is programmed to direct the laser 528 and laser beam at a specific location of one of the bottom platen assembly 120 and/or the top platen assembly 122 for a given pass of a compression head assembly 114. In some embodiments, the controller 532 is programmed to move the laser 528 and laser beam based on signals received from the visual camera 534 for each individual compression head assembly 114.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

As used in this application, “upstream” and “downstream” refer to locations of objects relative to a location of another object with respect to the process direction, where “downstream” refers to the direction of flow of the materials to be processed through the described apparatus.

As used in this application, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values include, consist essentially, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used in this application have the same meaning as is commonly understood by one of ordinary skill in the art to which this disclosure belongs. The terms “first”, “second”, “third”, and the like, as used herein do not denote any order or importance, but rather are used to distinguish one element from another. The term “or” and “and/or” is meant to be inclusive and mean either, all, or any combination of the listed items. In addition, the terms “connected” and “coupled” are not restricted to physical or mechanical connections or couplings, and can include electrical connections or couplings, whether direct or indirect. Direct connection and/or coupling can include such connections and/or couplings where no intermittent connection or component is present between two endpoints, components or items. Indirect connection and/or coupling can include where there is one or more intermittent or intervening connections and/or couplings present between respective endpoints, components or items.

Approximating language, as used in this application throughout the specification and claims, may be applied to modify any quantitative representation that could permissibly vary without resulting in a change in the basic function to which it is related. Accordingly, a value modified by a term or terms, such as “about,” “substantially,” or “essentially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used in this application, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

While only certain features of the described apparatus have been illustrated and described in this application, many modifications and changes will occur to those skilled in the art. It is, therefore, to be understood that the appended claims are intended to cover all such modifications and changes that fall within the true spirit of the invention.

1. A feed system for delivering raw ingredients to an apparatus for making food product, the feed system comprising:
a first feed assembly configured to dose and deliver the raw ingredients to the apparatus, the first feed assembly including a first hopper that stores a first amount of the raw ingredients therein, a first metering unit that apportions a dose of the raw ingredients having a predetermined volume from the first amount of the raw ingredients in the first hopper, and a first dosing unit that receives the dose of the raw ingredients from the first metering unit and delivers the dose of the raw ingredients to the apparatus,
wherein the first hopper includes a hopper housing that stores the first amount of the raw ingredients therein in a shallow bed and a distribution unit configured to move the first amount of the raw ingredients in the hopper housing to urge a portion of the first amount of the raw ingredients into the first metering unit while preventing bridging of the raw ingredients.

2. The feed system of claim 1, wherein the distribution unit moves the first amount of the raw ingredients in a wave such that a first area of the hopper housing holds a first height of the raw ingredients and a second area of the hopper housing holds a second height of the raw ingredients that is less than the first height.

3. The feed system of claim 1, wherein the distribution unit includes a mixing blade that moves relative to the hopper housing to move the first amount of the raw ingredients in the hopper housing.

4. The feed system of claim 1, further comprising a storage container assembly including a storage container that stores the raw ingredients therein and configured to distribute the raw ingredients to the first hopper, wherein one of the storage container and the first hopper include a filling duct having an outlet configured to direct the raw ingredients into the hopper housing and the outlet is offset from a central axis of the hopper housing.

5. The feed system of claim 2, further comprising a storage container assembly including a storage container that stores the raw ingredients therein and configured to distribute the raw ingredients to the first hopper, wherein the storage container assembly includes a valve configured to selectively open and close to control a volume of the first amount of the raw ingredients delivered to the hopper housing of the first hopper and a controller programmed to open and close the valve such that the second height of the raw ingredients has a height in the hopper housing which exposes a bottom of the hopper housing in the second area of the hopper housing when viewed from above.

6. The feed system of claim 1, wherein the first metering unit includes a first gate formed to include a first gate hole, a second gate spaced apart from the first gate and formed to include a second gate hole, and a metering plate located between the first gate and the second gate and formed to include a metering hole, wherein the metering hole cooperates with the first gate and the second gate to cause the dose to have the predetermined volume, wherein the metering plate is configured to move between:
a first position in which the metering hole is aligned with the first gate hole to allow the raw ingredients in the first hopper to pass through the first gate hole and into the metering hole and misaligned with the second gate hole so that the raw ingredients in the metering hole is blocked from escaping the metering hole by the second gate, and
a second position in which the metering hole is misaligned with the first gate hole to block additional raw ingredients from the first hopper from passing into the metering hole and aligned with the second gate hole to allow the dose of the raw ingredients to move out of the metering hole and the second gate hole and into the first dosing unit so that the first dosing unit stores the dose of the raw ingredients having the predetermined volume.

7. The feed system of claim 6, wherein the metering plate includes a metering wall formed to define the metering hole and a side wall that extends from the metering wall to form a cavity in the metering plate that opens toward the second gate to allow inadvertent egress of the raw ingredients into the cavity.

8. The feed system of claim 6, wherein the metering plate is formed to include a relief hole that is spaced apart from the metering hole to allow inadvertent ingress of the raw ingredients to pass between the first gate and the metering plate.

9. The feed system of claim 4, further comprising a base and a moving frame, the base having a base frame and guide rail coupled with the base frame, the moving frame coupled with the guide rail and with the first feed assembly and configured to move the first feed assembly along a feed path relative to the base frame.

10. The feed system of claim 9, wherein the base further includes a drive belt coupled with the base frame and the moving frame includes a frame body coupled with the first feed assembly, a guide coupled with the frame body and with the guide rail of the base, and a drive unit coupled with the frame body, wherein the drive unit is engaged with the drive belt to selectively move the frame body along the feed path in a first direction and a second direction.

11. The feed system of claim 10, wherein the drive unit includes a motor and a spindle engaged with the drive belt and driven by the motor selectively to cause the spindle to rotate along the drive belt to move the moving frame along the feed path.

12. The feed system of claim 9, wherein the storage container is a first storage container, the feed system further comprising a second feed assembly that includes a second hopper that includes a second storage container, a second hopper housing, a second metering unit, and a second dosing unit, and wherein the hopper housing and the second hopper housing are coupled for movement together relative to the first storage container and the second storage container.

13. The feed system of claim 12, wherein the first storage container stores a first raw ingredient and the second storage container stores a second raw ingredient different than the first raw ingredient, the first storage container and the second storage container both configured to selectively deliver their respective raw ingredient to the first feed assembly and the second feed assembly.

14. The feed system of claim 6, wherein the first dosing unit includes a dosing plate formed to include a dosing hole, a dosing plate actuator configured to move the dosing plate, a dosing gate formed to include a dosing gate hole, and a dosing gate actuator configured to move the dosing gate independent of the dosing plate actuator; optionally, wherein the dosing plate is located between the second gate and the dosing gate; optionally, wherein the dosing plate is movable between a first position in which the dosing hole is aligned with the second gate hole and a second position in which the dosing hole is aligned with a hole formed in the apparatus, optionally;
wherein the dosing gate is movable between a first position in which the dosing gate hole is misaligned with the dosing hole, the second gate hole, and the hole formed in the apparatus while the dosing plate is in the first position and the second position in which the dosing gate hole is misaligned with the dosing hole while the dosing plate is in the second position, and a third position in which the dosing gate hole is aligned with the dosing hole and the hole formed in the apparatus while the dosing plate is in the second position to allow the raw ingredients to move from the dosing hole to the hole formed in the apparatus.

15. A method for delivering raw ingredients to an apparatus for making food product, the method comprising:
moving a first amount of a raw material in a hopper housing,
directing the raw material from the hopper housing into a metering unit to provide a dose of the raw ingredients having a predetermined volume,
moving the dose of the raw ingredients to a dosing unit, and
delivering the dose of the raw ingredients from the dosing unit to the apparatus for making the food product.

16. The method of claim 15, wherein moving the first amount of the raw material in the hopper housing includes forming a wave of the raw material such that a first portion of the raw material in the hopper housing has a first height and a second portion of the raw material in the hopper housing has a second height.

17. The method of claim 15, further comprising selectively conducting a volume of the raw ingredients from a first storage container to the hopper housing so that at least a portion of the bottom of the hopper housing is visible when viewed from above during the step of moving the first amount of the raw material in the hopper housing.

18. The method of claim 17, wherein the hopper housing extends around an axis and conducting the volume of the raw ingredients from the first storage container to the hopper housing includes directing the raw ingredients toward a location offset from the axis of the hopper housing.

19. The method of claim 15, further comprising moving the hopper housing, the metering unit, and the dosing unit about feed path relative to the apparatus.

20. The method of claim 15, further comprising aligning the dosing unit with the apparatus before delivering the dose of the raw ingredients from the dosing unit to the apparatus for making the food product.
